(19) United States
(12) Patent Application Publication
(10) Pub. No.: US 2001/0017629 A1
(43) Pub. Date: Aug. 30, 2001

(54) Methods and apparatus for drawing contours of objects in video games

(75) Inventors: Hiroshi Minagawa, Tokyo (JP); Yoshinori Tsuchida, Tokyo (JP)

Correspondence Address: BEYER WEAVER & THOMAS LLP, P.O. BOX 778, BERKELEY, CA, 94704-0778, US

(73) Assignee: Square Co., Ltd.

(21) Appl. No.: 09/751,350

(22) Filed: Dec. 27, 2000

(30) Foreign Application Priority Data
Dec. 28, 1999 (JP) P1999-374875

(51) Int. Cl. G09G 5/00

(52) U.S. Cl. 345/619

(57) ABSTRACT

A contour-drawing object is generated in the size greater than a corresponding object (S35, S37). The color of the contour-drawing object is set to a contour color (S39). Then the object and contour-drawing object are drawn by the Z sort method. For drawing them, polygons of the object are added to a sort table as usual, while polygons of the contour-drawing object are added to the sort table after such a shift of the first address of the sort table that the contourdrawing object is located behind the object in the actual depth with respect to the view point (S45). Since the polygons are drawn in order from the most distant polygon in the sort table from the view point, the object is written over the contour-drawing object. Finally, there remains only the contour part of the contour-drawing object surrounding the entire edge of the object, outside the object and the contours are drawn in the contour color.

Provided also is a video game apparatus, which comprises a computer-readable storage medium storing a program for a video game which draws an object comprised of a plurality of polygons in a virtual space and a computer which reads out at least one of said program from said recording medium to perform, by reading out at least one of said program from said storage medium, the generation of contour drawing objects.

### BACKGROUND OF THE INVENTION

1. Field of the Invention

The present invention relates to a video game and, more particularly, to the technology of drawing the contours around an object in a virtual space.

2. Related Background Art

In recent years studies have been conducted on the technology of non-photorealistic rendering in the field of video games. The non-photorealistic rendering technology is, for example, the technology of expressing an animation image called a cartoon by CG (Computer Graphics). One of such non-photorealistic rendering techniques is a technique for drawing the contours around a three-dimensional object when drawing a two-dimensional image of the three-dimensional object.

For example, Japanese Patent Application Laid-Open No. Hei-7-85310 describes the following technology. In the technology, when displaying a two-dimensional image of a three-dimensional object approximated to a polyhedron, sides forming each facet of the polyhedron are defined as units. Whether each side is a side to be displayed as a contour is determined based on a predetermined algorithm. Then the contours of the polyhedron are displayed by detecting the sides to be displayed as the contours, based on the determination result, and displaying the detected sides in a different type of line, a different line width, or a different line color.

Japanese Patent Application Laid-Open No. Hei-7-160905 describes the technology described below. When displaying a two-dimensional image of a threedimensional object approximated to a polyhedron, sides of polygons forming the polyhedron displayed are traced in pixel units of a display screen. Whether each side is a side to be displayed as a contour is determined based on predetermined algorithm. Then the contours of the object are displayed by detecting the sides to be displayed as the contours, based on the determination result, and displaying the detected sides in a different line color.

In the conventional technologies, in order to display the contours, it was necessary to decompose the polygons or the three-dimensional object as a display object into units of sides of facets or polygons and determine whether each side was a side to be displayed as a contour. It was also necessary to implement the enhanced display of the sides of the object being a display object, based on the result of the determination.

In summary, detecting which sides qualified as contours for the object and implementing the enhanced display of the sides of the object so detected were both necessary before the contours could be displayed

### SUMMARY OF THE INVENTION

An object of the present invention is to provide a contour drawing technique capable of drawing the contours around an object, without execution of the process of detecting the contours for the object as a target of contour drawing.

According to a first aspect of the present invention, an object drawing method in a video game for drawing an object in a virtual space is a method comprising: generating a contour-drawing object having a size greater than that of the object; determining positions of the contour-drawing object and the object so that the contour-drawing object thus generated is positioned behind the object when observed from the view point; and drawing the object at the position thus determined and drawing the contour-drawing object in an optional contour color and at the determined position except for an overlapping portion between the object and the contour-drawing object when observed from the view point.

With introduction of the contour-drawing object, it becomes possible to draw the contours around the object, without carrying out the process of detecting the contours for the object as a target of contour drawing.

It is also possible to set the position of the contour-drawing object at the position of the original object and set the position of the object closer to the view point than the normal position thereof. It is also possible to set the position of the contour-drawing object behind the object whose position has been already set. Namely, the point is that the positions of the object and the contour-drawing object are determined so that the contour-drawing object is positioned relatively behind the object when observed from the view point.

The method can also be arranged so that in the drawing described above, the contour-drawing object and the object are drawn at the respective determined positions in the order named.

It is also possible to employ such a configuration that in the drawing described above, a hidden surface removal treatment using a Z buffer is carried out to draw the object at the determined position and draw the contour-drawing object at the determined position and in the optional contour color. The present invention can also be applied to drawing techniques using a Z buffer.

It is also possible to employ such a configuration that in generating the contour-drawing object, the contour-drawing object is generated by expanding the object. There are cases wherein the contour-drawing object is different only in the size from the object. There are also cases wherein the shape is also somewhat different.

It is also possible to employ such a configuration that in the determining described above, the positions of the contour-drawing object and the object are determined so that the contour-drawing object generated appears outside the edge of the object when observed from the view point.

It is also possible to employ such a configuration that in the drawing described above, the object is drawn at the determined position and the contourdrawing object is drawn at the determined position except for the overlapping portion between the object and the contour-drawing object when observed from the view point, by use of texture mapping.

Further, it is also possible to employ such a configuration that in the drawing, the object is drawn at the determined position and the contour-drawing object is drawn at the determined position except for the overlapping portion between the object and the contour-drawing object when observed from the view point, by use of texture mapping with texture varying with a lapse of time. In this configuration, for example, the contours of the object can be drawn so as to undergo dynamic change with a lapse of time. There are also cases wherein the texture is switched between a plurality of textures, without using the texture varying with time.

According to a second aspect of the present invention, an object drawing method in a video game for drawing an object comprised of a plurality of polygons is a method comprising: generating a contour-drawing object having a size greater than that of the object; setting a distance from a view point of each polygon forming the contour-drawing object and the object so that the contour-drawing object thus generated is positioned behind the object when observed from the view point; and drawing each polygon forming the object and drawing each polygon forming the contour-drawing object in an optional contour color in accordance with a drawing order of the polygons resulting from sequencing of the polygons from the greatest distance from the view point, set in the setting. This is the method of drawing the polygons by the so-called Z sort method.

According to a third aspect of the present invention, an object drawing method in a video game is a method comprising: generating a contour-drawing object having a size greater than that of the object; setting a distance from a view point of each polygon forming the contour-drawing object and the object so that the contour-drawing object thus generated is positioned behind the object when observed from the view point; and drawing a pixel according to a polygon having a distance closest to the view point, set in the setting, out of polygons projectable into the pixel, wherein when the polygon projected into the pixel is a polygon forming the object, the pixel is drawn according to the polygon and wherein when the polygon projected into the pixel is a polygon forming the contour-drawing object, the pixel is drawn in an optional contour color. This method is one using the so-called Z buffer method.

The program can be made so that the computer executes the object drawing method in the video game according to either of the first to the third aspects of the present invention. In that case, the above-stated modifications for the first to the third aspects can also be applied to the program. The program according to the present invention is stored in a storage medium or a storage device, for example, such as the CD-ROM (Compact Disc-Read Only Memory), DVD (Digital Versatile Disc), floppy disc, memory cartridge, memory, hard disc, and so on. The video game apparatus described below can be realized by making the computer read in the program stored in the storage medium or storage device. The storage media permit the program according to the present invention to be distributed and sold readily as software products independent of the apparatus. Further, when the program according to the present invention is carried out by the hardware such as the computer, the graphics technology of the present invention can be carried out readily by the hardware such as the computer or the like.

According to a fourth aspect of the present invention, a video game apparatus, which comprises a computer-readable storage medium storing a program for a video game which draws an object in a virtual space; and a computer which reads out at least one of said program from said recording medium to perform, by reading out at least one of said program from said storage medium, generating a contour-drawing object having a size greater than that of the object; determining positions of the contour-drawing object and the object so that the contour-drawing object thus generated in said generation is positioned behind the object when observed from a view point; and drawing the object at the position thus determined in the position determination and drawing the contour-drawing object in an optional contour color and at the position determined by the position determination except for an overlapping portion between the object and the contour-drawing object when observed from the view point.

The drawing means described above can also be structured so as to draw the contour-drawing object and the object at the respective positions determined by the position determining means, in the order named.

According to a fifth aspect of the present invention, a video game apparatus, which comprises a computer-readable storage medium storing a program for a video game which draws an object comprised of a plurality of polygons in a virtual space; and a computer which reads out at least one of said program from said recording medium to perform, by reading out at least one of said program from said storage medium, generating means for generating a contour-drawing object having a size greater than that of the object; setting a distance from a view point of each polygon forming the contour-drawing object and the object so that the contour-drawing object thus generated is positioned behind the object when observed from the view point; and drawing each polygon forming the object and drawing each polygon forming the contour-drawing object in an optional contour color in accordance with a drawing order of the polygons resulting from sequencing of the polygons from the greatest distance from the view point.

According to a sixth aspect of the present invention, a video game apparatus, which comprises a computer-readable storage medium storing a program for a video game which draws an object comprised of a plurality of polygons in a virtual space; and a computer which reads out at least one of said program from said recording medium to perform, by reading out at least one of said program from said storage medium, generating a contour-drawing object having a size greater than that of the object; setting a distance from a view point of each polygon forming the contour-drawing object and the object so that the contour-drawing object thus generated by said generation is positioned behind the object when observed from the view point; and drawing a pixel according to a polygon having a distance closest to the view point, set by said setting, out of polygons projectable into the pixel, wherein when the polygon projected into the pixel is a polygon forming the object, the pixel according to the polygon is drawn and wherein when the polygon projected into the pixel is a polygon forming the contour-drawing object, the pixel in an optional contour color is drawn.

According to a seventh aspect of the present invention, a video game apparatus to draw an object in a virtual space is an apparatus comprising: a computer; and a computer-readable storage medium storing a program to be executed by the computer, wherein the program is structured so as to make the computer perform: a generating process of generating a contour-drawing object having a size greater than that of the object; a position determining process of determining positions of the contour-drawing object and the object so that the contour-drawing object thus generated in the generating process is positioned behind the object when observed from a view point; and a drawing process of drawing the object at the position thus determined in the position determining process and drawing the contour-drawing object in an optional contour color and at the position determined in the position determining process except for an overlapping portion between the object and the contour-drawing object when observed from the view point.

### BRIEF DESCRIPTION OF THE DRAWINGS

FIG. 1 is a block diagram to show the structure of a home-use game machine;

FIG. 2 is a block diagram to show a state of RAM in Embodiment 1;

FIG. 3 is a drawing to show an example of a polygon table;

FIG. 4 is a drawing to show an example of an object;

FIG. 5 is a drawing to show an example of a vertex table;

FIG. 6 is a drawing to show an example of an outline control table;

FIG. 7 is a schematic diagram for explaining a a sort table;

FIG. 8 is a flowchart to show a flow of display processing in Embodiments 1 and 2;

FIG. 9 is a flowchart to show a processing flow of a drawing arithmetic process in Embodiment 1;

FIG. 10 is a schematic diagram for explaining processing carried out on the occasion of adding a polygon forming an object to the sort table;

FIG. 11 is a flowchart to show a processing flow of an outline setting process in Embodiment 1;

FIG. 12 is a schematic diagram for explaining processing carried out on the occasion of adding a polygon forming a contour-drawing object to the sort table;

FIG. 13 is a schematic diagram for explaining the sort table in a state in which the first address is set back after storage of polygons of the contour-drawing object and the object;

FIG. 14 is a flowchart to show a processing flow of a texture control process;

FIG. 15 is a schematic diagram for explaining the texture varying with a lapse of time;

FIG. 16 is a schematic diagram for explaining how the texture varies with a lapse of time;

FIG. 17 is a block diagram to show a state of RAM in Embodiment 2;

FIG. 18 is a diagram to show an example of a pixel table;

FIG. 19 is a schematic diagram for explaining pixel identification numbers;

FIG. 20 is a diagram to show an example of a Z buffer;

FIG. 21 is a flowchart to show a processing flow of the drawing arithmetic process in Embodiment 2;

FIG. 22 is a flowchart to show a processing flow of the outline setting process in Embodiment 2;

FIG. 23 is a display image to show an example of the object as a target of contour drawing;

FIG. 24 is a display image to show an example of the contour-drawing object with a single contour color;

FIG. 25 is a display image to show an example of a contoured object;

FIG. 26 is a display image to show an example of the contoured object in the case of the depth adjustment value of 0;

FIG. 27 is a display image to show an example of the contoured object in the case of the depth adjustment value of 12;

FIG. 28 is a display image to show an example of the contoured object in the case of the depth adjustment value of 30;

FIG. 29 is a display image to show an example of the contour-drawing object in which the texture of lateral stripes is mapped;

FIG. 30 is a display image to show an example of the contoured object with the lateral stripe texture;

FIG. 31 is a display image to show an example of the contoured object with the lateral stripe texture in the case of the depth adjustment value of 0;

FIG. 32 is a display image to show an example of the contoured object with the lateral stripe texture in the case of the depth adjustment value of 12; and

FIG. 33 is a display image to show an example of the contoured object with the lateral stripe texture in the case of the depth adjustment value of 30.

### DETAILED DESCRIPTION OF THE PREFERRED EMBODIMENTS

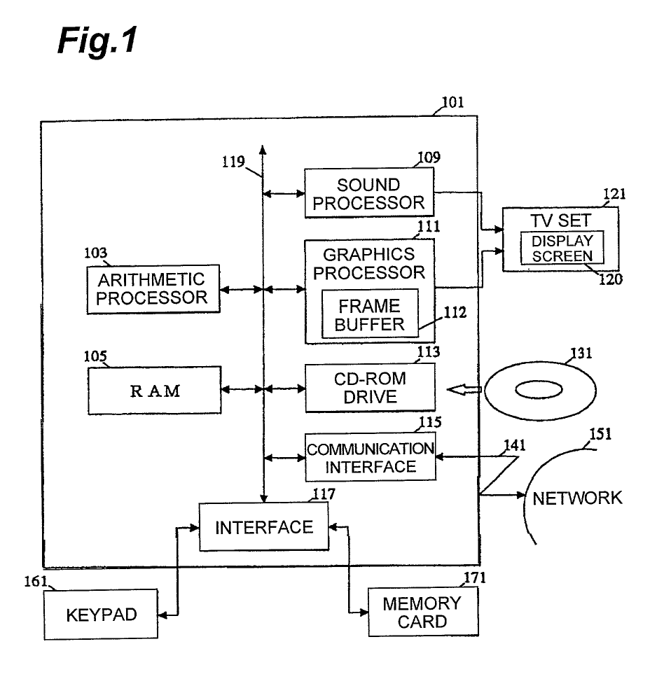

In carrying out the present invention by means of a computer program of an embodiment of the present invention, an example of a home-use game machine 101 for carrying out the computer program is presented in FIG. 1. The home-use game machine 101 is provided, for example, with an arithmetic processing unit 103, a RAM (Random Access Memory) 105, a sound processing unit 109, a graphics processing unit 111, a CD-ROM drive 113, a communication interface 115, and an interface section 117, which are connected to an internal bus 119. The graphics processor 111 incorporates a frame buffer 112.

The sound processor 109 and the graphics processor 111 of the home-use game machine 101 are connected to a TV set 121 having a display screen 120. A CD-ROM 131, which is capable of being loaded on or unloaded from the CD-ROM drive 113, is loaded on the CD-ROM drive 113. The communication interface 115 is connected via a communication medium 141 to a network 151. A keypad 161 with control buttons, and a memory card 171 are connected to the interface section 117.

The arithmetic processor 103 incorporates a CPU, a ROM (Read Only Memory), etc. and executes a program stored in the CD-ROM 131 to control the home-use game machine 101. The RAM 105 is a work area of the arithmetic processor 103. The memory card 171 is a storage area for saving data to be referenced by the program. When the program under execution by the arithmetic processor 103 provides a command to carry out sound output, the sound processor 109 interprets the command and outputs a sound signal to the TV set 121.

In accordance with a drawing command from the arithmetic processor 103, the graphics processor 111 generates image data to write it in the frame buffer 112. Then it outputs a signal for display on the image screen 120 of the thus written image data, to the TV set 121. The CD-ROM drive 113 reads the program and data on the CD-ROM 131 out thereof. The communication interface 115 is connected via the communication medium 141 to the network 151 to perform input/output control of data communication with another computer or the like. The interface section 117 outputs input information from the keypad lGl, to the RAM 105, and the arithmetic processor 103 interprets the input from the keypad 161 to carry out arithmetic processing.

The program and data of the embodiment according to the present invention are initially stored, for example, in the CD-ROM 131. Then the program and data are read by the CD-ROM drive 113 upon execution and transferred to the RAM 105. The arithmetic processor 103 handles the program and data of the embodiment according to the present invention, loaded on the RAM 105, to output a drawing command to the graphics processor 111. Intermediate data is saved in the RAM 105. The graphics processor 111 executes processing according to the drawing command from the arithmetic processor 103, writes the image data in the frame buffer 112, and outputs a signal for display thereof on the display screen 120, to the TV set 121.

Detailed descriptions will be given below of the algorithm of the program of the embodiment according to the present invention carried out in the home-use game machine 101 as described above, and the data used therein.

Embodiment 1

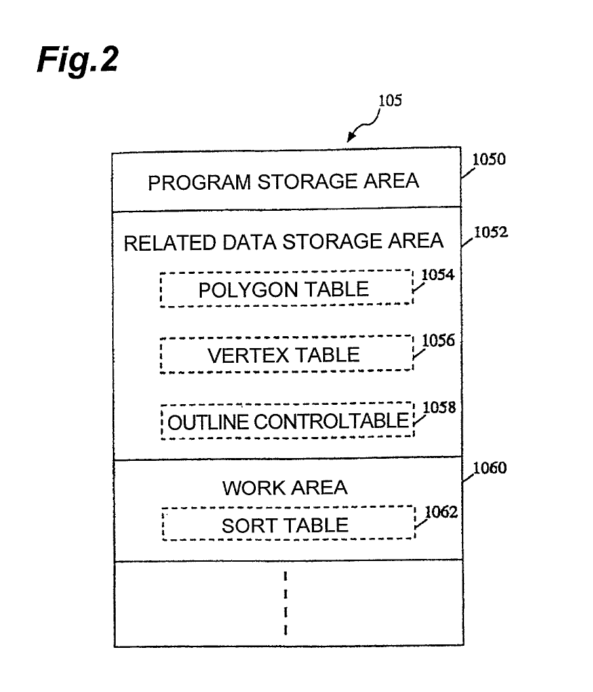

FIG. 2 shows a state of the RAM 105, for example, where the program and data of the embodiment according to the present invention, which were stored in the CD-ROM 131, are loaded on the RAM 105 by the CD-ROM drive 113 and the program of the embodiment according to the present invention is under execution. In the present embodiment the RAM 105 consists of at least a program storage area 1050, a related data storage area 1052, and a work area 1060. The program saved in the program storage area 1050 will be described hereinafter. The related data storage area 1052 includes a polygon table 1054, a vertex table 1056, and an outline control table 1058. The work area 1060 includes a sort table 1062.

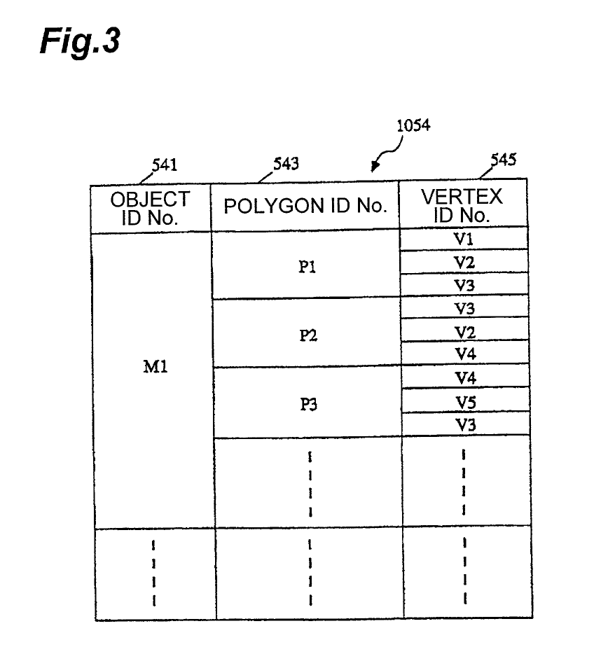

An example of the polygon table 1054 included in the related data storage area 1052 is presented in FIG. 3. The polygon table 1054 is a table for specifying an object or objects to be drawn, polygons constituting each object, and vertexes constituting each of the polygons. For specifying each object to be drawn, there is a column 541 provided for storing object identification (ID) numbers. In the example of FIG. 3 the object ID number of M1 is indicated in the column 541.

For specifying the polygons constituting each object, there is a column 543 provided for storing polygon identification numbers. In the example of FIG. 3, the polygon ID numbers of P1, P2, and P3 are indicated for three polygons constituting the object M1 in the column 543.

For specifying the vertexes constituting each polygon, there is a column 545 provided for storing vertex identification numbers. In the example of FIG. 3, the vertex ID numbers of V1, V2, and V3 are indicated for the vertexes constituting the polygon P1. Further, the vertex ID numbers of V3, V2, and V4 are indicated for the vertexes constituting the polygon P2. In addition, the vertex ID numbers V4, V5, and V3 are indicated for the vertexes constituting the polygon P3.

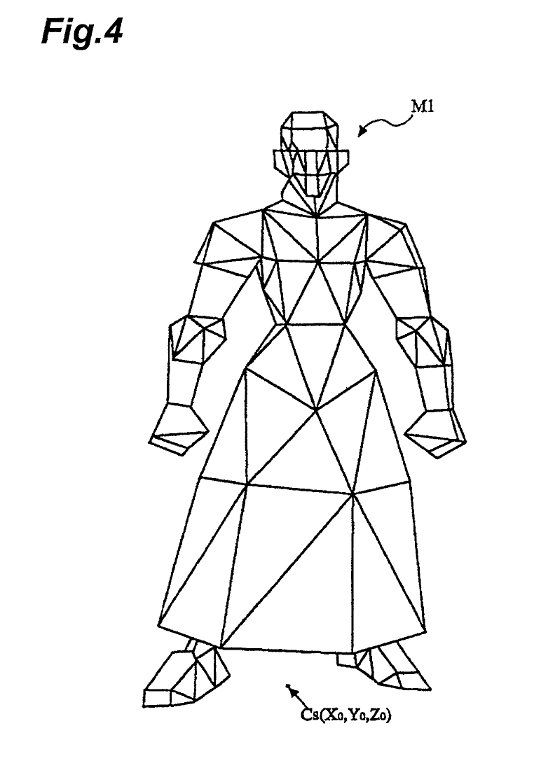

For example, the object M1 to be drawn is composed of an aggregate of polygons as illustrated in FIG. 4. In the polygon table 1054 the ID numbers of the polygons constituting the object M1 are stored in the column 543 of the polygon ID numbers corresponding to the object M1. The ID numbers of vertexes constituting each polygon are stored in the column 545 of vertex ID numbers corresponding to each polygon.

As illustrated in FIG. 4, a reference position Cs (X0, Y0, Z0) is set for the object, and a position of each polygon is defined as displacement from this reference position Cs. As described hereinafter, the reference position of object is also used for determining a position of a contour-drawing object.

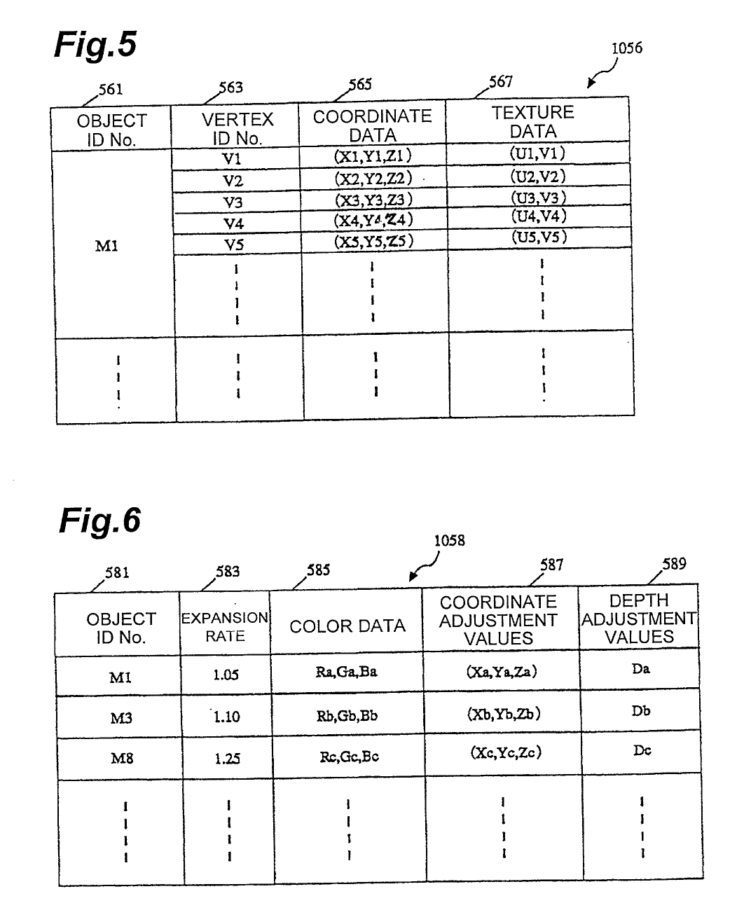

An example of the vertex table 1056 included in the related data storage area 1052 is presented in FIG. 5. The vertex table 1056 is a table for specifying the object(s) to be drawn, vertexes of polygons constituting each object, coordinate values of the vertexes, and texture coordinates. For specifying the object(s) to be drawn, there is a column 561 provided for storing the object ID number(s). In the example of FIG. 5 the object ID number of M1 is indicated in the column 561.

For specifying the vertexes of polygons constituting each object, there is a column 563 provided for storing the vertex ID numbers. In the example of FIG. 5 the vertex ID numbers of V1, V2, V3, V4, and V5 are indicated in the column 563. For specifying the coordinate values of each vertex, there is a column 565 provided for storing vertex data. In the example of FIG. 5 the coordinate values of the vertex V1 are (X1, Y1, Z1). The coordinate values of the vertex V2 are (X2, Y2, Z2). The coordinate values of the vertex V3 are (X3, Y3, Z3). The coordinate values of the vertex V4 are (X4, Y4, Z4). The coordinate values of the vertex V5 are (X5, Y5, Z5).

For specifying the texture coordinates of each vertex, there is a column 567 of texture data provided. In the example of FIG. 5 the texture coordinates of the vertex V1 are (U1, V1). The texture coordinates of the vertex V2 are (U2, V2). The texture coordinates of the vertex V3 are (U3, V3). The texture coordinates of the vertex V4 are (U4, V4). The texture coordinates of the vertex V5 are (U5, V5).

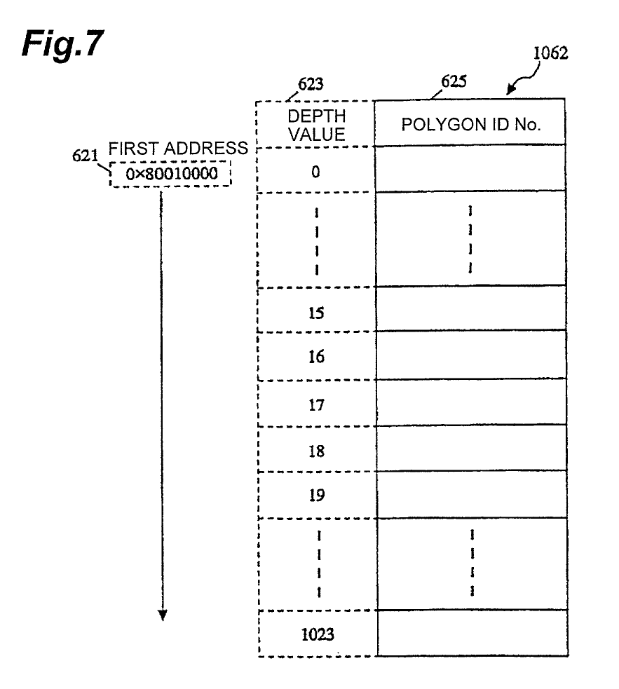

An example of the outline control table 1058 included in the related data storage area 1052 is presented in FIG. 6. The outline control table 1058 is a table for storing data necessary for contour drawing for each object as a target of contour drawing. An object ID number of each object as a target of contour drawing is stored in a column 581 of object ID number in FIG. 6. In the example of FIG. 6, the objects M1, M3, and M8 are designated as targets of contour drawing.

A column 583 of expansion rate in FIG. 6 stores expansion rates of contour-drawing objects generated against the objects as targets of contour drawing, to the original objects. In the example of FIG. 6, the contour-drawing object against the object M1 is generated by expanding the object M1 at the expansion rate of 1.05. The contour-drawing object against the object M3 is generated by expanding the object M3 at the expansion rate of 1.10. The contour-drawing object against the object M8 is generated by expanding the object M8 at the expansion rate of 1.25.

A column 585 of color data in FIG. 6 stores contour colors of the objects in correspondence to the objects as targets of contour drawing. In FIG. 6 each of the contour colors is a single color. In the example of FIG. 6 the contour color of the object M1 is (Ra, Ga, Ba). The contour color of the object M3 is (Rb, Gb, Bb). Any color such as black, white, brown, blue, or the like can be set as a contour color of a single color. The contour color of the object M8 is (Rc, Gc, Bc).

A column 587 of coordinate adjustment value in FIG. 6 stores coordinate adjustment values for such movement of each contour-drawing object so as to provide the corresponding object as a target of contour drawing with even contours, for example. The coordinate adjustment values are values in the world coordinate system.

Under normal circumstances, when a contour-drawing object is generated by simply expanding an object as a target of contour drawing at an expansion rate stored in the expansion rate column 583, the object as a target of contour drawing is not provided with even contours. The reference position of the contour-drawing object needs to be moved from the reference position of the object as a target of contour drawing by the coordinate adjustment values stored in the coordinate adjustment value column 587 so as to provide the object as a target of contour drawing with even contours.

It is, however, noted that an object as a target of contour drawing does not always have to be provided with even contours. For example, where only a certain part is intended to be provided with a thick contour, the coordinate adjustment values are determined so as to realize the thick contour only in the certain part and they are stored in the coordinate adjustment value column 587.

In the example of FIG. 6 the coordinate adjustment values of the contour-drawing object for the object M1 are (Xa, Ya, Za). The coordinate adjustment values of the contour-drawing object for the object M3 are (Xb, Yb, Zb). The coordinate adjustment values of the contour-drawing object for the object M8 are (Xc, Yc, Zc).

A column 589 of depth adjustment value in FIG. 6 stores adjustment values for shifting the first address value of the sort table described hereinafter. The position of a contour-drawing object is set behind an object as a target of contour drawing when observed from the view point. As a consequence, the object as a target of contour drawing is drawn as it is, whereas the contour-drawing object is drawn only in a part not overlapping with the object as a target of contour drawing when observed from the view point.

In order to set the contour-drawing object behind the object as a target of contour drawing with respect to the view point, it is also possible to adjust coordinates of each vertex of polygons forming the contour-drawing object, but the number of transactions to be handled becomes large in that case. The present embodiment employs the Z sort method as a hidden surface removal method. In the sort table used in the Z sort method, storage positions of polygons of each contour-drawing object are adjusted by shifting the first address of the sort table. By shifting the first address of the sort table, the position of the contour-drawing object is set behind the object as a target of contour drawing when observed from the view point.

In the example of FIG. 6 the depth adjustment value is Da on the occasion of adding each polygon of the contour-drawing object corresponding to the object M1, to the sort table. The depth adjustment value is Db on the occasion of adding each polygon of the contour-drawing object corresponding to the object M3, to the sort table. The depth adjustment value is Dc on the occasion of adding each polygon of the contour-drawing object corresponding to the object M8, to the sort table.

The point herein is that the contour-drawing object is relatively positioned behind the original object as a target of contour drawing when observed from the view point. Therefore, it can also be contemplated that the contour-drawing object is set at the position of the original object and the original object is set at a position closer to the view point.

An example of the sort table 1062 included in the work area 1060 is presented in FIG. 7. The sort table 1062 is a table for determining a drawing order in making use of the Z sort method representing a technique for hidden surface removal. A polygon ID number of a polygon to be drawn is added to an address corresponding to a depth value being a distance of the drawn polygon from the view point. As a result, the polygons are sorted according to their depth values. The larger the depth value, the more distant the polygon from the view point. The drawing is carried out in the decreasing order of the depth values. As a consequence, images of polygons closer to the view point are drawn over images of farther polygons, thus effecting hidden surface removal.

In the example of FIG. 7 the polygon ID number of the depth value 0 will be stored in the first address 621 of the sort table 1062. In practice, a pointer to data of that polygon is stored in the address corresponding to the depth value of the polygon.

In FIG. 7, 0x80010000 of the first address 621 and the depth value column 623 are indicated only for understanding of the present embodiment. Under normal circumstances there exists only the column 625 of polygon ID number. Namely, the portions indicated by the dotted lines in FIG. 7 are presented for easier understanding of the present embodiment. In this example, the smaller the depth value, the nearer the polygon to the view point. Thus 1023 is the most distant. Each address of the polygon ID number column 625 is assigned successively in the increasing order of the depth values from the first address.

A depth value of each polygon is, for example, an average of depth values of the respective vertexes constituting the polygon. Another possible method is to use the largest depth value out of the depth values of the vertexes constituting the polygon. It is also possible to use the smallest depth value. Further, it is also possible to use a depth value of a predetermined point in the polygon, for example, a depth value at the center of gravity thereof.

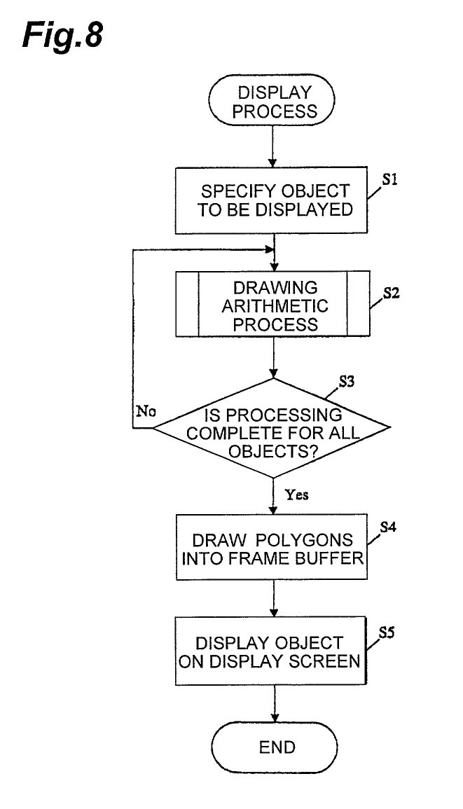

The algorithm of the program in the embodiment 1 will be described below referring to FIGS. 8, 9, 10, 11, 12, 13, 14, 15 and 16.

Upon starting, based on the operating system stored in the ROM or the like, the arithmetic processor 103 makes the CD-ROM drive 113 read the program and data necessary for execution of image processing and a game out of the CD-ROM 131 and transfer them to the RAM 105. Then the arithmetic processor 103 executes the program transferred to the RAM 105, thereby implementing the processing described below.

It is noted here that among the control and processing carried out in the home-use game device 101 there are also some cases wherein practical control and processing is carried out by circuitry except for the arithmetic processor 103 in cooperation therewith. For convenience' sake of description, the control and processing associated with the arithmetic processor 103 will be described below as being assumed to be carried out directly by the arithmetic processor 103.

In practice the program and data necessary for execution of the image processing and the game are successively read out of the CD-ROM 131 according to the preceding circumstances of processing in response to a command from the arithmetic control unit 103 to be transferred to the RAM 105. In the description hereinafter, however, explanation will be omitted about the reading of data from the CD-ROM 131 and the transfer thereof to the RAM 105 for easier understanding of the invention.

The main flow concerning the display is illustrated in FIG. 8. First, objects to be displayed are specified (step Sl). Next, a drawing arithmetic process is carried out for one object out of the objects to be displayed (step S2). This drawing arithmetic process will be detailed hereinafter. It is then determined whether the drawing arithmetic process has been completed for all the objects to be displayed (step S3).

If there exists an unprocessed object among the objects to be displayed, the flow will return to step S2. When the process has been completed for all the objects to be displayed, a drawing process is carried out in the frame buffer 112 (step S4). Then the image data stored in the frame buffer 112 is displayed on the display screen 120 of the TV set 121 (step S5).

In the present embodiment the drawing process is carried out in association with the hidden surface removal treatment by the Z sort method. Namely, each of the polygons is written in the frame buffer 112 in order from the farthest polygon, i.e., from the polygon with the largest depth value with respect to the view point in the sort table 1062 illustrated in FIG. 7. Drawing of a certain polygon is carried out according to the processing described below. Interpolation is effected, based on coordinates and colors at the respective vertexes forming the polygon, to compute colors of respective pixels inside the polygon. If texture mapping is not required, the colors thus computed as described above will be written as colors of the respective pixels in the frame buffer 112. If the texture mapping is required on the other hand, interpolation will be carried out based on the texture coordinates of the respective vertexes forming the polygon to compute texture coordinates of the respective pixels inside the polygon. Then colors generated by use of texel values in the texture coordinates and the colors of the pixels computed above will be written as colors of the respective pixels in the frame buffer 112.

The position of the contour-drawing object is determined behind the object as a target of contour drawing when observed from the view point. If the contour-drawing object located in back does not overlap with the object as a target of contour drawing at all, the contour-drawing object will be drawn prior to the object as a target of contour drawing.

If the contour-drawing object located back overlaps with the object as a target of contour drawing on the other hand, their polygons will be written in the frame buffer 112 in order from the most distant polygon with respect to the view point in the sort table 1062. Therefore, there are some polygons of the object as a target of contour drawing that are written in the frame buffer 112 prior to the polygons of the contour-drawing object.

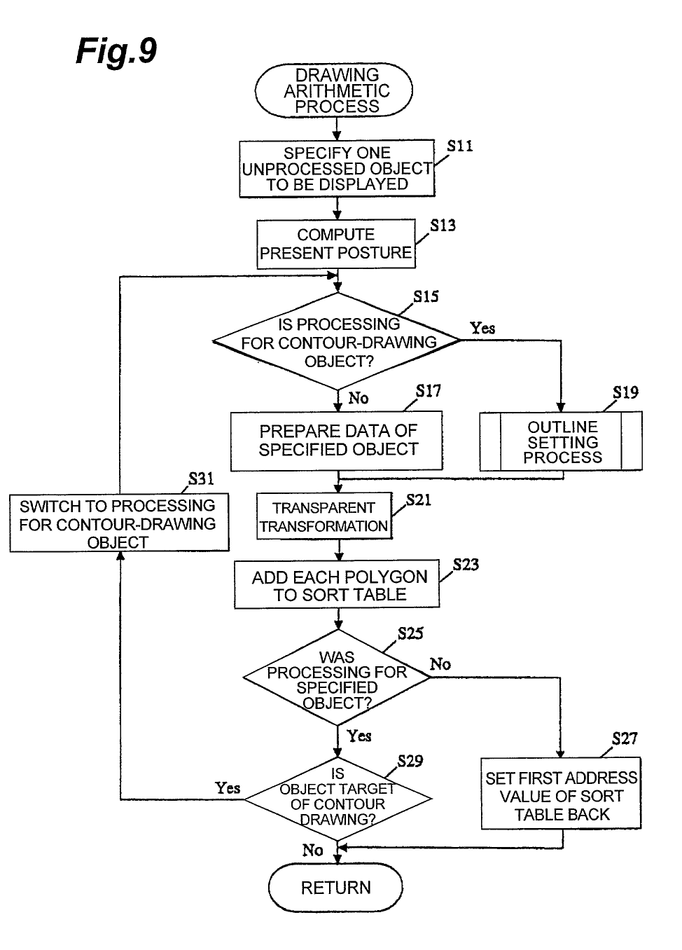

Next, the drawing arithmetic process of step S2 will be described referring to FIG. 9. First, one unprocessed object to be displayed is specified (step S11). The present posture of the specified object is computed (step S13). Positions of the polygons constituting the object are modified so as to match with the present posture. It is then determined whether the present processing is for a contour-drawing object (step S15). Since in the initial stage one unprocessed object was specified in step S11, the processing is not for a contour-drawing object. Thus the flow transfers to step S17.

In step S17, data of the unprocessed object specified is prepared. Then the data of the unprocessed object thus prepared is subjected to transparent transformation (step S21). The transparent transformation is a process of transforming coordinate values of respective vertexes of each polygon in the world coordinate system to coordinate values in the screen coordinate system. The transparent transformation yields distances from the view point at the respective vertexes of each polygon, i.e., depth values, for each of the polygons constituting the unprocessed object specified.

Then the following processing is carried out for each of the polygons constituting the unprocessed object specified. Namely, a depth value of each polygon is computed from the depth values at the respective vertexes of the polygon, for each of the polygons. For example, in the case of a triangular polygon, the depth value of the polygon is determined as an average of three depth values of the three vertexes. A storage address is computed from the first address of the sort table 1062, using the depth value of each polygon thus computed, and each polygon is added to the sort table 1062 (step S23). Actually stored in the sort table 1062 is a pointer to the data of each polygon. For adding each polygon forming the unprocessed object specified to the sort table 1062, no shift is given to the first address of the sort table 1062. The polygons are added to the sort table under the initial setting.

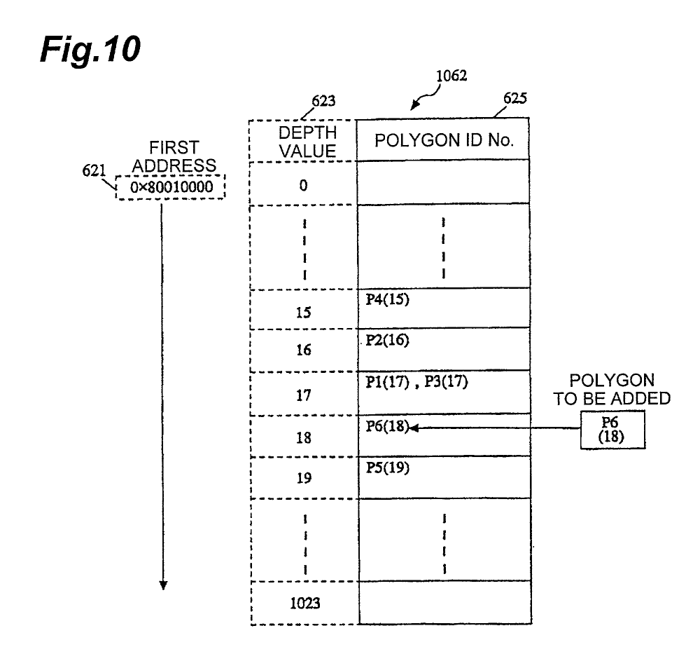

FIG. 10 is a drawing for explaining the processing for adding a polygon to the sort table 1062. The first address 621 is the same as in FIG. 7. The polygon of P4 is already stored in the address corresponding to the depth value 15. The depth value in parentheses is described at the rear of the polygon ID number of P4. The illustration of depth values is given for the description hereinafter, but the depth values are not stored actually. The polygon P2 is stored in the address of the depth value 16. The polygons P1 and P3 are stored in the address corresponding to the depth value 17. The polygon P5 is stored in the address corresponding to the depth value 19. For adding the polygon P6, the polygon P6 is added to the address corresponding to the depth value 18, using the data of the depth value 18 of the polygon P6.

Returning to FIG. 9, it is then determined whether the above processing has been done for one unprocessed object specified (step S25). Since the processing has been made for the unprocessed object specified in the first execution, the processor transfers to step S29. In step S29, it is determined whether the unprocessed object specified is a target of contour drawing. In this step it can be determined by determining whether the unprocessed object is an object stored in the outline control table 1058, with reference to the outline control table 1058 of FIG. 6.

If the unprocessed object is an object not stored in the outline control table 1058, the processor will transfer to step S3 of FIG. 8, because the process of drawing the contours is not necessary. If the unprocessed object is an object stored in the outline control table 1058 on the other hand, the processor will move to step S31. In step S31 the object to be processed is switched from one unprocessed object specified, to a corresponding contour-drawing object.

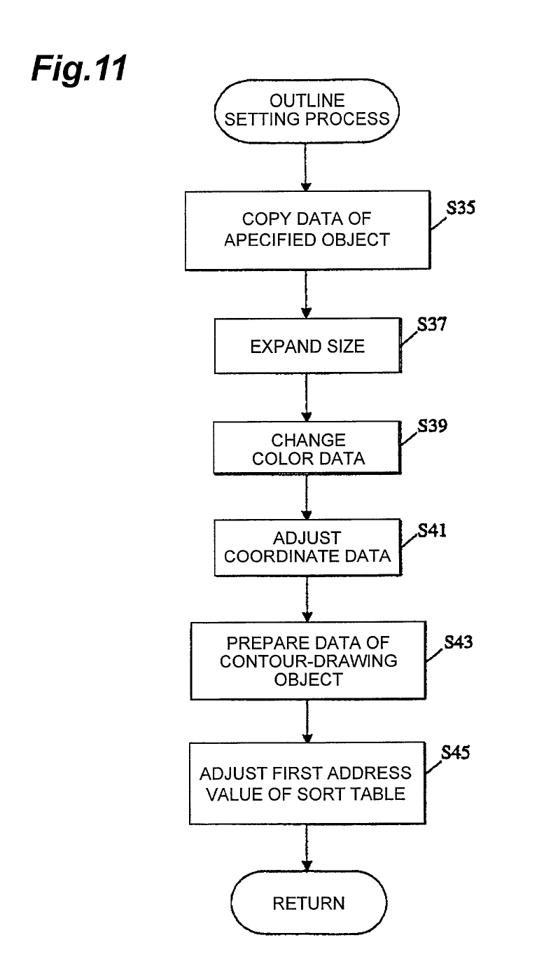

Going back to step S15, the processor again determines whether the present process is for a contour-drawing object. Since the object to be processed was switched to the contour-processing object in step S31, the processor transfers to step S19 this time. An outline setting process is carried out in step S19. The outline setting process will be described in detail referring to FIG. 11.

In FIG. 11 the data of the unprocessed object specified (the original object as a target of contour drawing) is first copied to be prepared as data of the contour-drawing object (step S35). Then the size of the contour-drawing object is expanded from the size of the original object (step S37). The value in the expansion rate column 583 of the outline control table 1058 is used for the expansion of the size of the contour-drawing object. The expansion of the size can be implemented by moving the vertexes along directions of normal vectors at the vertexes of each polygon. Then the color data of the contour-drawing object is changed (step S39). The data in the color data column 585 of the outline control table 1058 is used as the color data of the contour-drawing object. The color in the color data column 585 is set as a contour color.

In addition, adjustment is made for the coordinate data of the contour-drawing object (step S41). The coordinate values in the coordinate adjustment value column 587 of the outline control table 1058 are used for the adjustment of the coordinate data. Namely, the reference position of the contour-drawing object is shifted by the coordinate adjustment values. Then the data of the contour-drawing object generated is prepared for the transparent transformation (step S43). In the last stage, the first address of the sort table 1062 is adjusted by the data in the depth adjustment value column 589 of the outline control table 1058 (step S45). Namely, the value of the first address of the sort table 1062 is shifted. After this stage, the flow returns to step S21 of FIG. 9.

In FIG. 9 the data of the contour-drawing object prepared is subjected to the transparent transformation (step S21). The transparent transformation yields the distances from the view point at the respective vertexes of each polygon, i.e., the depth values thereof, for each of the polygons constituting the contour-drawing object.

In the next stage the following processing is carried out for each of the polygons constituting the contour-drawing object. Namely, the depth value of each polygon is computed from the depth values at the respective vertexes of the polygon, for each of the polygons. For example, in the case of a triangular polygon, an average of three depth values at the three vertexes is calculated and is used as a depth value of the polygon. Then a storage address is computed from the first address of the sort table 1062, using the depth value of the polygon thus computed, and each polygon is added to the sort table 1062 (step S23).

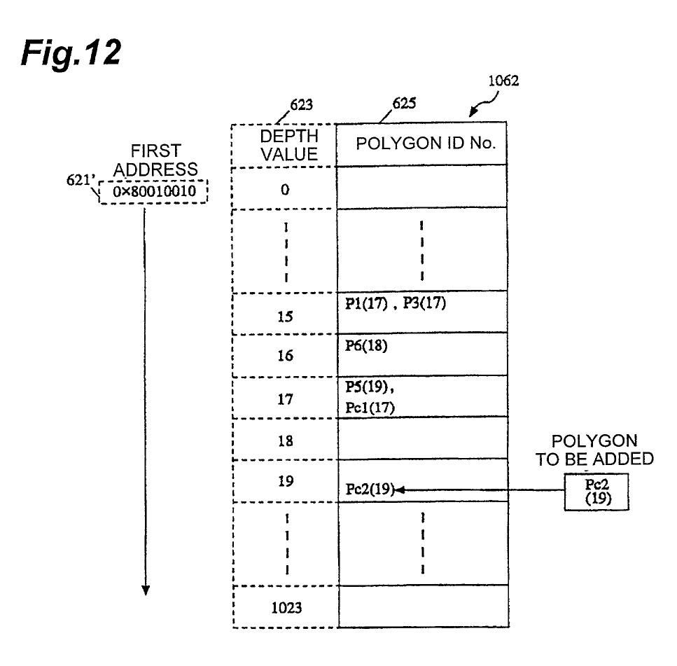

The first address of the sort table 1062 was adjusted in step S45 of FIG. 11. FIG. 12 shows the adjusted state of the first address. In the sort table 1062 of FIG. 12, the first address 621 is shifted by 16 bytes, from 0x80010000 to 0x80010010 (the first address 621′). Namely, the address corresponding heretofore to the depth value 2 is carried down to the first address 621′ and all the addresses thereafter are also carried down in the same way. Since the first address is shifted as in step S45, there is the need for provision of extra areas above and below the sort table 1062.

In FIG. 12 the polygons P1 and P3 whose depth value was 17 before the adjustment of the first address are stored in the address corresponding to the depth value 15. The polygon P6 whose depth value was 18 before the adjustment of the first address is stored in the address corresponding to the depth value 16. The polygon P5 whose depth value was 19 before the adjustment of the first address is stored in the address corresponding to the depth value 17.

Also stored in the address corresponding to the depth value 17 is the polygon Pc1 of the depth value 17, which is a polygon forming the contour-drawing object. For adding the polygon Pc2 of the depth value 19 forming the contour-drawing object to the sort table 1062, it is stored in the address corresponding to the depth value 19 after the shift of the first address, as illustrated in FIG. 12.

Returning to FIG. 9, it is determined whether the object now under processing is the unprocessed object specified in step S11 (step S25). Since the contour-drawing object is now under processing, the flow transfers to step S27. In step S27 the first address of the sort table 1062 is put back to the original value in accordance with completion of the processing of the contour-drawing object (step S27). As described above, the adjustment of the first address of the sort table is effected only during the period of processing of the contour-drawing object. Then the processor transfers to step S3 of FIG. 8.

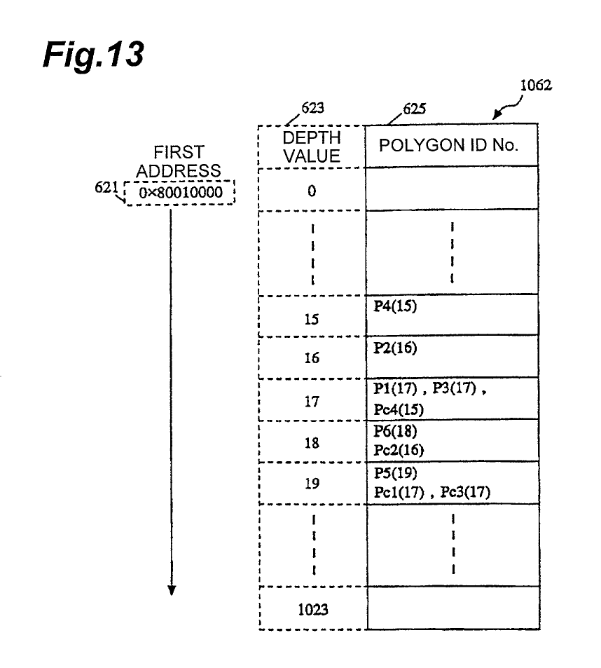

An example of the sort table 1062 at the stage of completion of step S27 is presented in FIG. 13. In the sort table 1062 of FIG. 13, the value of the first address is the original one. In the sort table 1062 the polygon P4 is stored in the address corresponding to the depth value 15. The polygon P2 is stored in the address corresponding to the depth value 16. The polygon P1 and polygon P3 are stored in the address corresponding to the depth value 17. The polygon Pc4 forming the contour-drawing object is also stored in the address corresponding to the depth value 17. As seen from the value in parentheses, the depth value of the polygon Pc4 is, however, actually 15. This means that the polygon Pc4 forming the contour-drawing object is stored in the address at the depth value of 2 behind the actual value. As a consequence, the contourdrawing object will be positioned at the depth value of 2 behind the corresponding object.

The polygon P6 and polygon Pc2 are stored in the address corresponding to the depth value 18. Since the actual depth value of the polygon Pc2 is 16, it is stored the depth value of 2 behind the actual value. The polygons P5, Pc1, and Pc3 are stored in the address corresponding to the depth value 19. Since the actual depth value of the polygons Pc1 and Pc3 is 17, they are stored the depth value of 2 behind the actual value.

Each of the polygons of the object and the contour-drawing object to be displayed is stored in the sort table 1062 as described above. Then the polygons are drawn into the frame buffer 112 in step S4 of FIG. 8 in order from the most distant polygon with respect to the view point in the sort table 1062. Then the image drawn in the frame buffer 112 is displayed on the display screen 120 of the TV set 121 in step S5.

In the above-stated processing, the depth values of the contour-drawing object were modified by adjusting the first address of the sort table 1062, in order to give precedence to increasing processing speed. It is, however, also possible to directly adjust the depth values of the respective polygons forming the contour-drawing object, without the adjustment of the first address. It is also possible to adjust the depth values of the respective vertexes of each polygon. The adjustment includes such arithmetic as addition, subtraction, multiplication, and so on.

Further, in the above-stated processing the first address of the sort table 1062 was adjusted during the period of processing of the polygons constituting the contour-drawing object. It is, however, also possible to employ such a configuration that the first address of the sort table 1062 is adjusted during the period of processing of the object corresponding to the contour-drawing object (i.e., during the period of processing of the original object as a target of contour drawing). This is the configuration in which each polygon forming the original object is stored at a position closer to the view point than the actual position in the sort table 1062. Instead of the adjustment of the first address of the sort table 1062, it is also possible to directly modify the depth values of the respective polygons forming the object.

In Embodiment 1, the contour-drawing object is generated in the size greater than the original object (step S37). Then the position of the contour-drawing object is finely adjusted, for example, so as to provide the whole edge of the object with contours of even thickness (step S41). After that, the object and the contour-drawing object are drawn by the Z sort method (step S4). Here each polygon forming the object is stored in the sort table 1062 as usual. On the other hand, each polygon forming the contour-drawing object is stored in the sort table 1062 with the shift of the first address of the sort table 1062 so as to be located behind the actual depth value from the view point (step S23).

Therefore, since the polygons are drawn in order from the farthest polygon from the view point in the sort table 1062, the original object is written over the contour-drawing object. Finally, there will remain only the part of the contour-drawing object surrounding the whole edge of the object, and this part will be drawn in the contour color.

As a result, the contours can be drawn for the object, without carrying out the process of detecting the contours for the object being a target of contour drawing.

For example, with the disclosure of Japanese Application Laid-open Publication No. Hei-7-8531 which is described in the related background art section, it was necessary to decompose a polyhedron or a three-dimensional object being a display object into units of sides of surfaces or polygons and determine whether each side is a side to be displayed as a contour, based on the predetermined algorithm, in order to draw the contours. For this reason, the processing for drawing the contours was extremely complicated.

In contrast with the referenced Publication, the method according to the embodiment 1 permits the contours to be drawn simply by generating the contour-drawing object by expanding the object as a target of contour drawing and setting an optional contour color, and by positioning the contour-drawing object behind the object. Therefore, the processing of drawing the contours is much simpler than before, so that the processing speed associated with the contour drawing can be increased.

The increase of processing speed associated with the contour drawing is preferable particularly for the video games. In the video games, the position and shape of the object to be displayed, camera works, etc. vary sequentially according to operation input and the like. Then a projection image according to the sequentially varying contents has to be displayed instantly on the screen. If the processing associated with the contour drawing is complex, the image display speed will be slow even if the contours can be drawn. It is thus important that the procedures associated with the contour drawing be simple, in order to perform the contour drawing without decrease in the display speed.

In the outline control table 1058 illustrated in FIG. 6, the data of contour color is stored in the color data column 585 under the precondition that the contour-drawing object is drawn in a single color. It is, however, also possible to implement the texture mapping for the contour-drawing object. For example, data concerning mapped texture, e.g. texture ID information, is stored in the color data column 585 of the outline control table 1058. Then, using the texture coordinates set at each vertex of the polygons forming the object corresponding to the contour-drawing object as they are, the texture indicated in the color data column 585 is mapped to each polygon forming the contour-drawing object.

In this case, the process of step S39 of FIG. 11 is skipped. In step S4 of FIG. 8, the interpolation is carried out based on the texture coordinates at the respective vertexes forming each polygon, for each of the polygons forming the contour-drawing object similarly as in the case of the normal object, to compute the texture coordinates of each pixel inside the polygon. Then a color generated using the texel value of the texture coordinates and the color of the pixels computed from the colors set at the respective vertexes of the polygon, is drawn as a color of each pixel into the frame buffer 112.

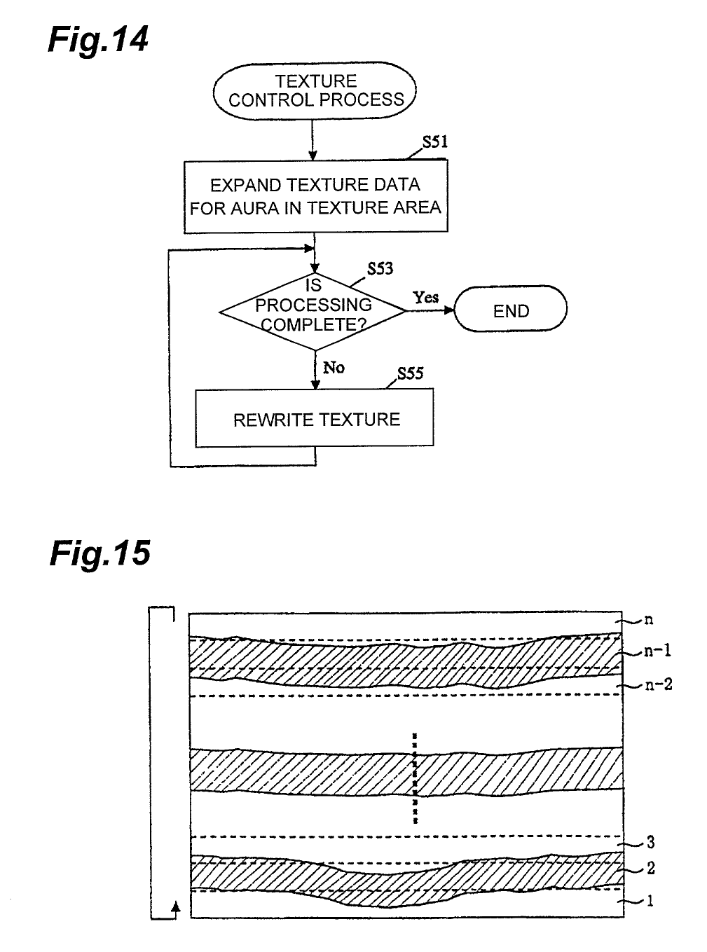

Further, the drawing mode of the contour part of the object can be dynamically altered with some contrivance on the texture used in the texture mapping to the contour-drawing object. For example, the processing illustrated in FIG. 14 is carried out in parallel to step S4 of FIG. 8. First, the texture data for contour drawing stored in the CD-ROM 131 is read into a texture area of the frame buffer 112 to be expanded in the texture area (step S51). Then the following processing is repeatedly carried out until the end of processing. The repeated processing is a rewriting process of texture (step S55).

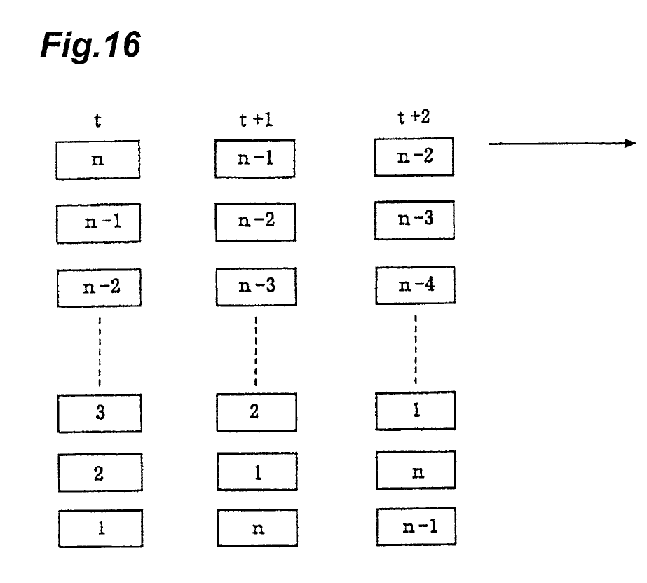

There are various methods for the rewriting process of texture. A first method is a method of dividing, for example, a texture including lateral stripe patterns into a plurality of laterally divided areas and rewriting the areas so as to move up in order, as illustrated in FIG. 15. The uppermost area moves to the bottom. For example, where numbers of 1 to n (n is a natural number) are assigned to the range from the lowermost to the uppermost areas as illustrated in FIG. 15, the areas are made to move as illustrated in FIG. 16.

Specifically, the state at the time t is as illustrated in FIG. 15, and at the time (t+1), the area of n is moved to the bottom and all the areas from 1 to (n−1) are moved one up. At the time (t+2), the area of (n−1) is moved to the bottom and all the areas of n and 1 to (n−2) are moved one up. The processing as described above is carried out repeatedly. The processing as described above permits expression of such a state that the stripe patterns move swingingly upward in the contour part of the object. It is also possible to divide the texture into a plurality of vertically separated areas and move the areas to the left or to the right with time.

A second method is a method of changing the lightness of texture with time. For example, the lightness of texture is altered by changing palettes of texture with time. It is also possible to employ a technique of directly changing each texel value of texture with time. For altering only the lightness, there is also a method without rewriting of texture. For example, when the lightness of the polygons of the contour-drawing object is altered with time, the final lightness after the mapping of texture is also altered. In this lightness-varying case, a slowly blinking state of the contour part of the object can be expressed.

Therefore, this method not only permits the drawing of the contour of object, but also permits expression of a state of a game character having an aura, for example. When the drawing mode of the contour part of a game character to be noted out of a plurality of game characters is altered dynamically, the user can be notified of the character to be noted.

As described above, the enhanced display mode of the object can also be reinforced with some contrivance on the contour drawing of the object.

Display Examples

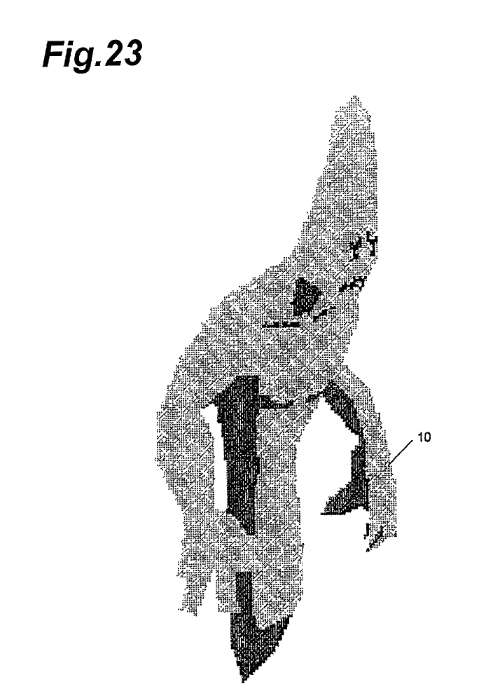

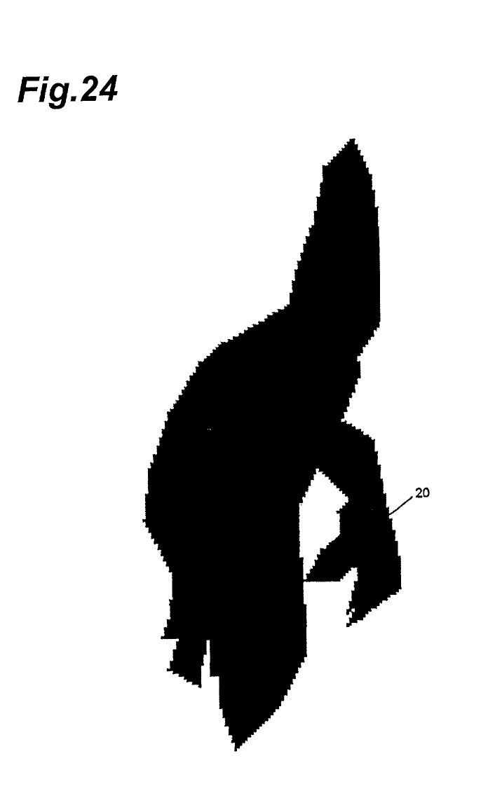

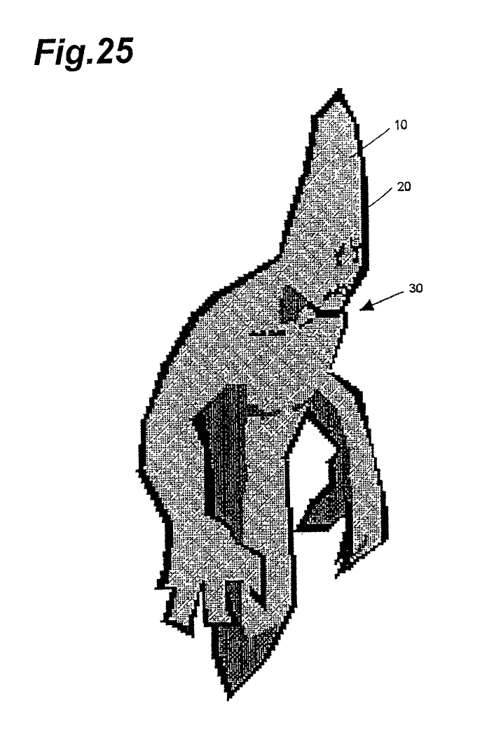

FIG. 23 shows a display example of an original object 10 as a target of contour drawing in the embodiment 1. As illustrated in FIG. 23, the object 10 is not provided with contours. Then, as illustrated in FIG. 24, the size of the original object 10 as a target of contour drawing is expanded (step S37), and the contour-drawing object 20 is generated in a predetermined contour color (steps S35, S39) in the expanded object. Then the depth value is adjusted as described above, whereby the contour-drawing object 20 is positioned behind the original object 10 being a target of contour drawing (step S23). By selecting an appropriate depth adjustment value, the object 30 with contours can be drawn as illustrated in FIG. 25 (step S4). In FIG. 25, the tip part of the right hand of the object 10 is placed in front of the body of the object 10, and this tip part of the right hand is also provided with contours.

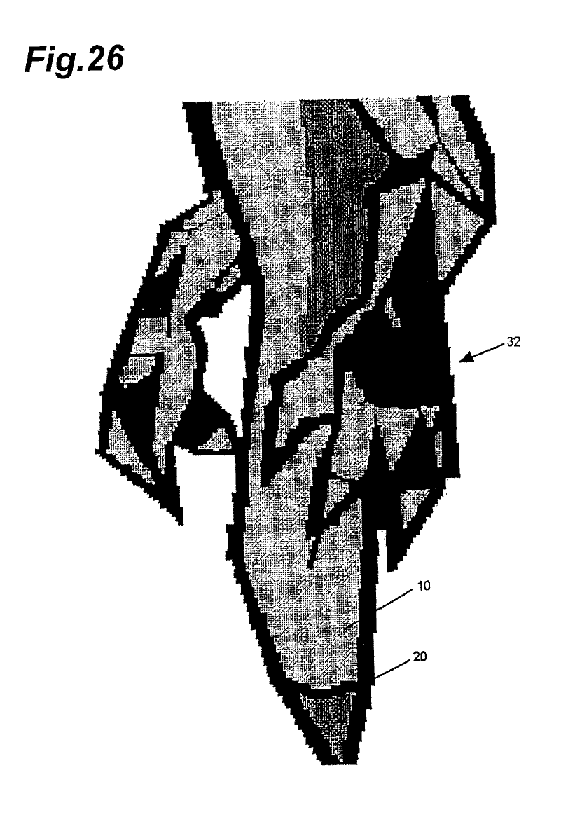

The difference in the contours depending upon the depth adjustment value will be described referring to FIG. 26 to FIG. 28. FIG. 26 shows a display example of a contoured object 32 where the depth adjustment value is 0, i.e., where the object 10 and the contour-drawing object 20 have an equal depth value. With setting of the equal depth value, there appear portions in which polygons of the contour-drawing object 20 are drawn and portions in which polygons of the object 10 are drawn, depending upon the order of drawing into the frame buffer 112. Therefore, the color of the polygons of the contour-drawing object 20, which should not appear in fact, is drawn inside the hands of the object.

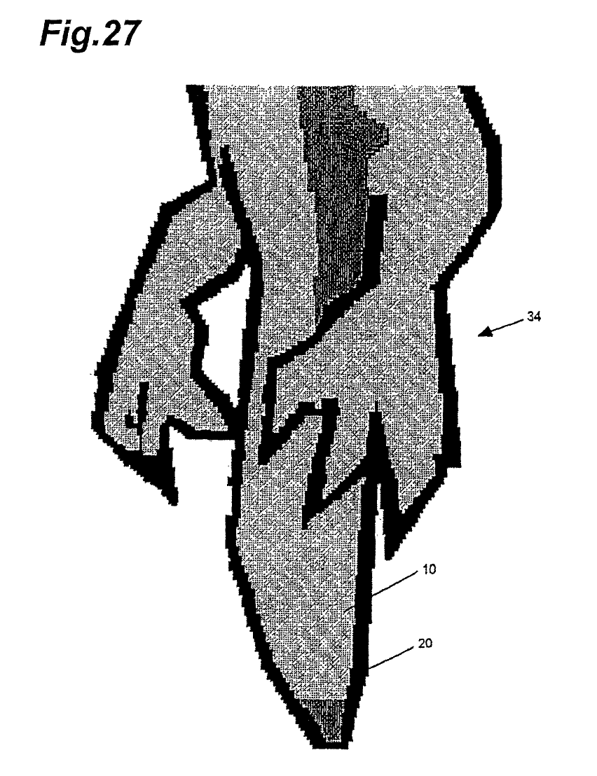

FIG. 27 is a display example of the contoured object 34 with the depth adjustment value of 12. The depth adjustment value is the same as in the case of FIG. 25, and the display also includes the contours at the tip part of the left hand of the object 10 which is positioned in front of the body of the object 10. Unlike the case of the depth adjustment of 0, no polygons of the contour-drawing object are drawn inside the hands of the object 10.

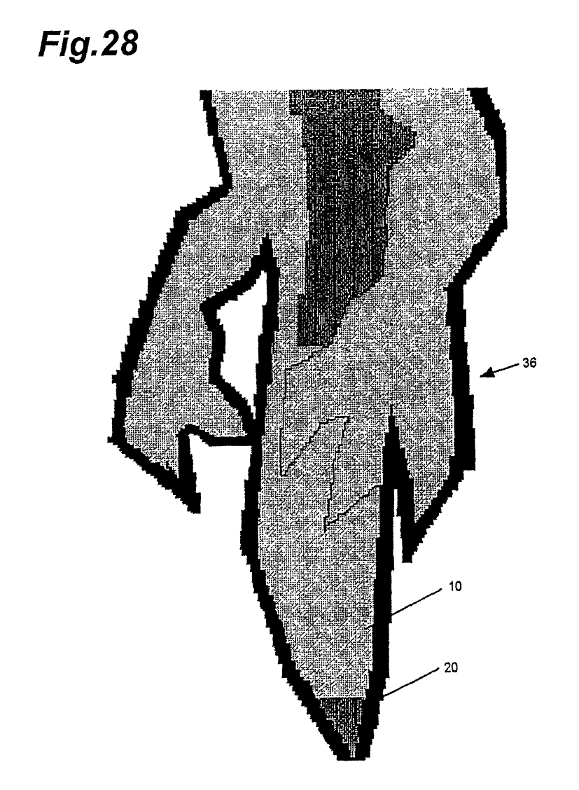

FIG. 28 is a display example of the contoured object 36 in the case of the depth adjustment value of 30. In the case of the depth adjustment value of 30, since the polygons of the contour-drawing object 20 are positioned behind the polygons of the body part of the object 10 with respect to the view point, no contours are drawn at the tip part of the left hand of the object 10 which is located in front of the body of the object 10.

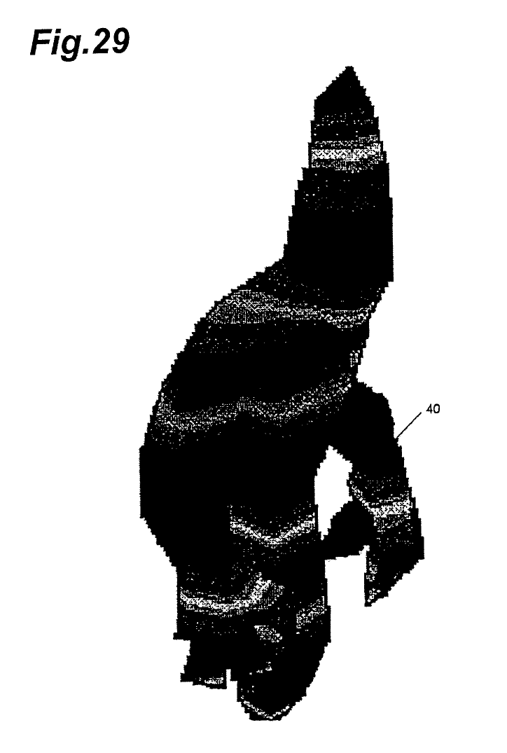

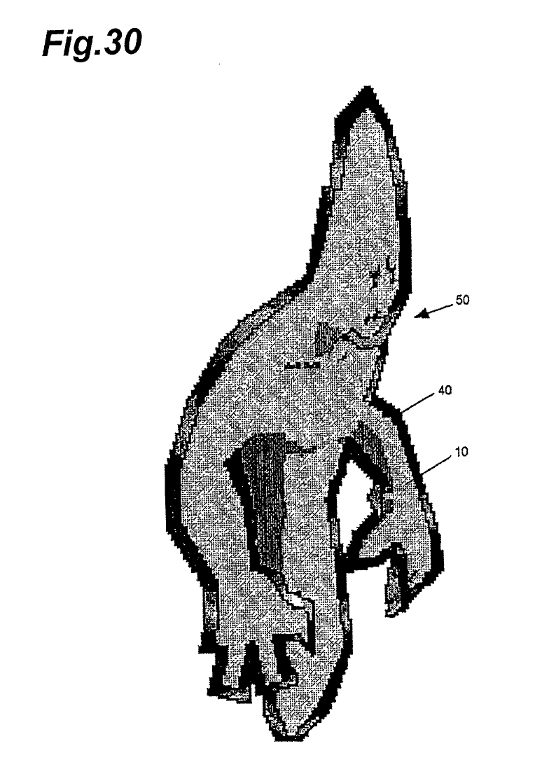

Next described is an example in which the contour part of the object illustrated in FIG. 23 is drawn so as to undergo the dynamic change with time. FIG. 29 shows a display example of the contour-drawing object 40 in which the texture of lateral stripes is mapped. When the contour-drawing object 40 is placed behind the object 10 illustrated in FIG. 23, under selection of an appropriate depth adjustment value, the object 50 can be drawn with the contours of lateral stripe texture, as illustrated in FIG. 30. If the texture is rewritten with a lapse of time as described referring to FIG. 14 to FIG. 16, the lateral stripes can be drawn so as to move gradually upward in the contour part.

Therefore, the present invention not only permits the drawing of the contours of object, but also permits, for example, the expression of the state of a game character having an aura, and the like. When the dynamic change is made for the drawing mode of the contour part of the game character to be noted, out of a plurality of game characters, the user can be notified of the character to be noted, in an easy-to-discriminate way.

As described above, the mode of enhanced display of object can be made substantial with some contrivance on the contour drawing of object.

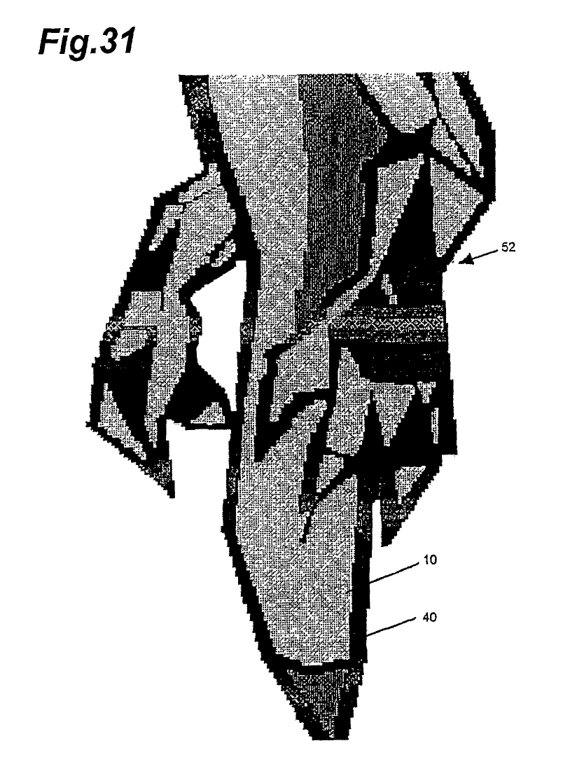

The difference in the contours depending upon the depth adjustment value will be described referring to FIG. 31 to FIG. 33. FIG. 31 shows a display example of the contoured object 52 where the depth adjustment value is 0, i.e., where the object 10 and contour-drawing object 40 have an equal depth value. Under the setting condition of the equal depth value, there appear portions in which polygons of the contour-drawing object 40 are drawn and portions in which polygons of the object 10 are drawn, depending upon the order of drawing into the frame buffer 112. Therefore, the color of polygons of the contour-drawing object 40, which should not appear in fact, is drawn inside the hands of the object.

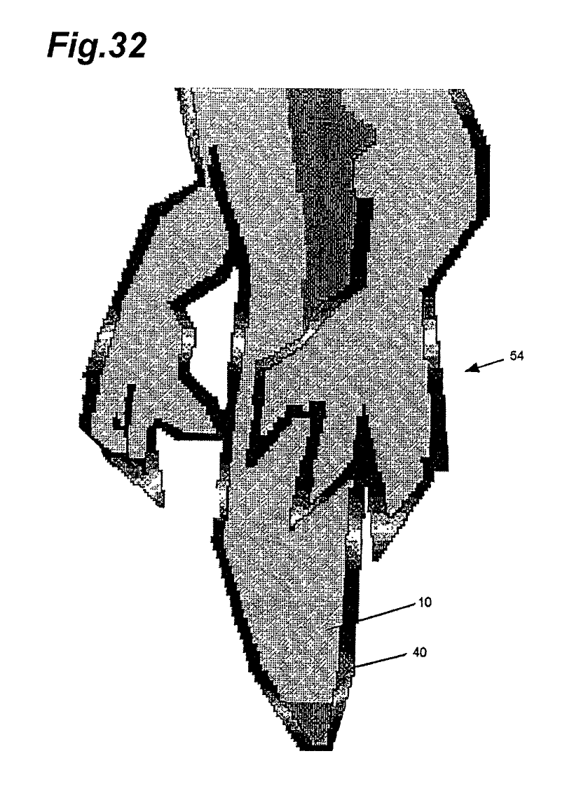

FIG. 32 is a display example of the contoured object 54 with the depth adjustment value of 12. The depth adjustment value is the same as in the case of FIG. 30, and the display also includes the contours at the tip part of the left hand of the object 10 which is positioned in front of the body of the object 10. Unlike the case of the depth adjustment of 0, no polygons of the contour-drawing object 40 are drawn inside the hands of the object 10.

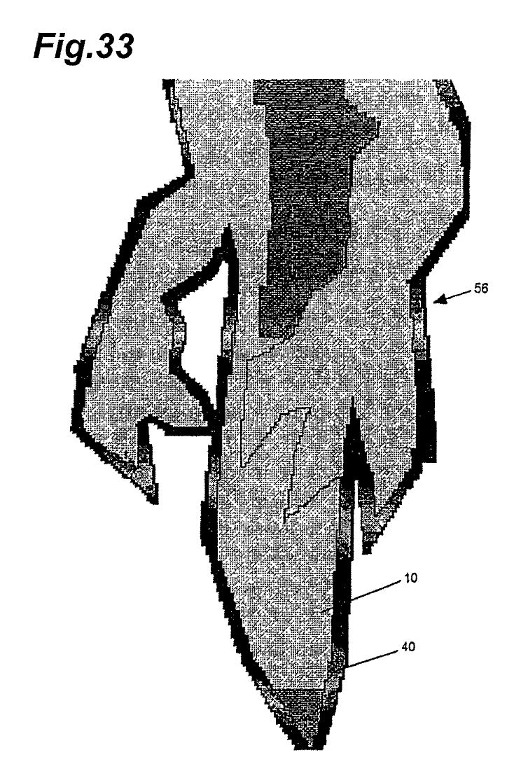

FIG. 33 is a display example of the contoured object 56 in the case of the depth adjustment value of 30. In the case of the depth adjustment value of 30, since the polygons of the contour-drawing object 40 are positioned behind the polygons of the body part of the object 10 with respect to the view point, no contours are drawn at the tip part of the left hand of the object 10 which is located in front of the body of the object 10.

Embodiment 2

Embodiment 1 employed the hidden surface removal using the Z sort method in the drawing process, whereas the present embodiment employs the hidden surface removal using the Z buffer in the drawing process.

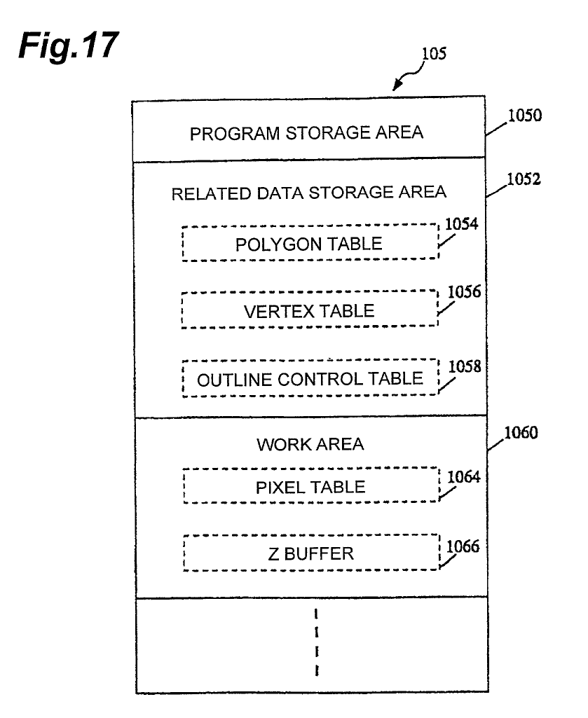

In the present embodiment 2, FIG. 17 shows a state of the RAM 105, for example, where the program and data of the embodiment 2, which were stored in the CD-ROM 131, are loaded in the RAM 105 by the CD-ROM drive 113 and the program of the embodiment 2 is executing. In the embodiment 2 the RAM 105 consists of at least the program storage area 1050, the related data storage area 1052, and the work area 1060. The program saved in the program storage area 1050 will be described hereinafter.

The related data storage area 1052 includes the polygon table 1054, the vertex table 1056, and the outline control table 1058. The structure so far is the same as in Embodiment 1. The work area 1060 includes a pixel table 1064 and a Z buffer 1066 in place of the sort table 1062. There are, however, also cases in which the pixel table 1064 and Z buffer 1066 are provided in the frame buffer 112.

The polygon table 1054 included in the related data storage area 1052 is the same as that in Embodiment 1 and is illustrated in FIG. 3. The polygon table 1054 is a table for specifying the object(s) to be drawn, polygons constituting each object, and vertexes constituting each of the polygons.

The vertex table 1056 included in the related data storage area 1052 is the same as in Embodiment 1 and is illustrated in FIG. 5. The vertex table 1056 is a table for specifying the object(s) to be drawn, vertexes of polygons forming each object, coordinate values of the vertexes, and texture coordinates.

The outline control table 1058 included in the related data storage area 1052 is the same as in Embodiment 1 as far as it is illustrated in FIG. 6. The outline control table 1058 is a table for saving the data necessary for the contour drawing for each of the objects as targets of contour drawing.

The object ID number column 581 stores the object ID numbers of the objects as targets of contour drawing. The expansion rate column 583 stores the expansion rates of the contour-drawing objects generated against the objects as targets of contour drawing, with respect to the original objects. The color data column 585 stores the contour colors of the objects, for each of the objects as targets of contour drawing.

The coordinate adjustment value column 587 stores the coordinate adjustment values for moving the contour-drawing objects, for example, so as to provide the objects as targets of contour drawing with even contours. The coordinate adjustment values are values in the world coordinate system. The depth adjustment value column 589 stores the values for adjustment of Z values at the respective vertexes of the polygons, for each polygon after the transparent transformation.

In the embodiment 2, as described hereinafter, the depth values of the respective vertexes of the polygons are shifted backward after the transparent transformation when viewed from the view point, upon drawing the polygons forming the contour-drawing object. The backward shift causes the contour-drawing object to be placed behind the corresponding object, as in Embodiment 1. By carrying out the processing as described above, only the part of the contour-drawing object not overlapping with the corresponding object will be drawn.

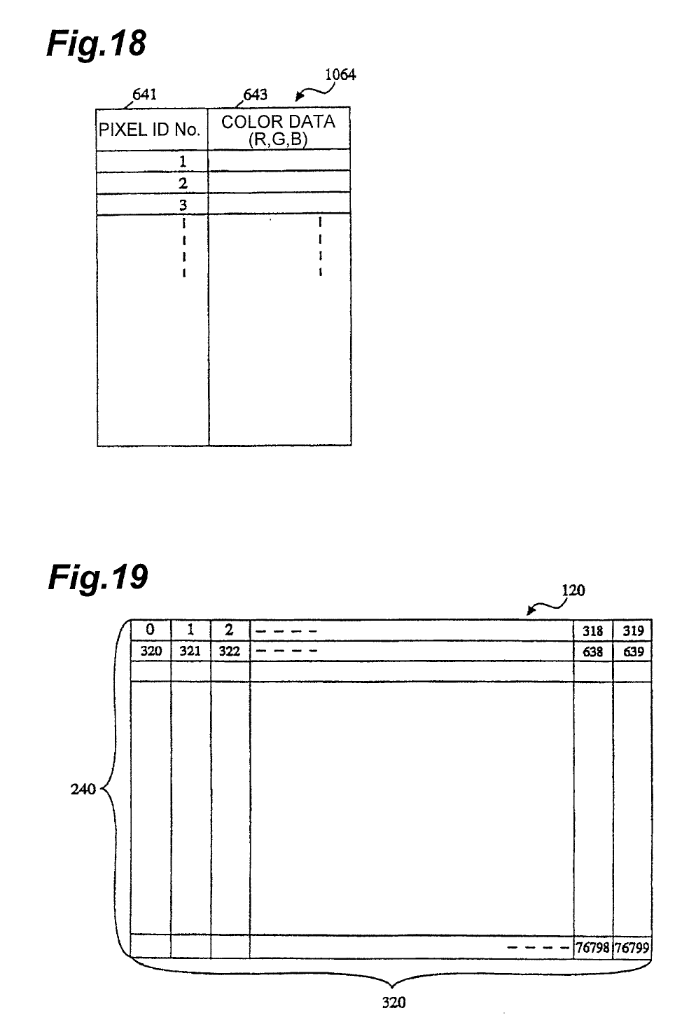

An example of the pixel table 1064 included in the work area 1060 is presented in FIG. 18. The pixel table 1064 is a table for storing color data to be displayed for the respective pixels. As illustrated in FIG. 18, the pixel table 1064 is provided with a column 641 of pixel ID number and a column 643 of color data (R, G, B). The pixel ID numbers are identification numbers assigned to the respective pixels of the display screen 120, as illustrated in FIG. 19. In the case of 240 pixels vertical and 320 pixels horizontal as illustrated in FIG. 19, the ID numbers are assigned in order, for example, from 0 at the left upper corner to 76799 at the right lower corner. The pixel table 1064 stores the color data per pixel ID number.

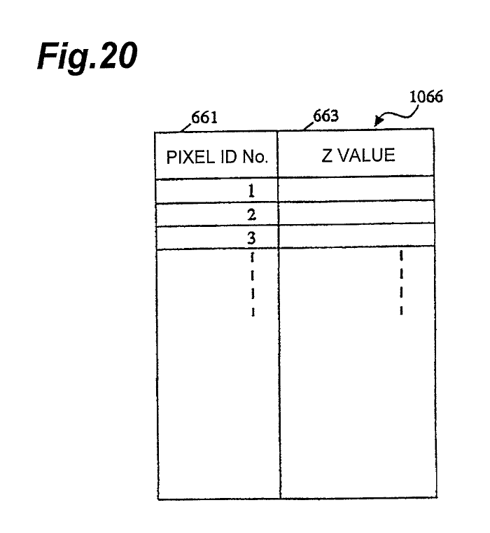

An example of the Z buffer 1066 included in the work area 1060 is presented in FIG. 20. The Z buffer 1066 is a table for storing the Z values of points (including the vertexes of polygons) inside the polygons, which are used as the basis of the color data stored in the pixel table 1064, for each of pixels. Therefore, the Z buffer 1066 is provided with a column 661 of pixel ID number and a column 663 of Z value.

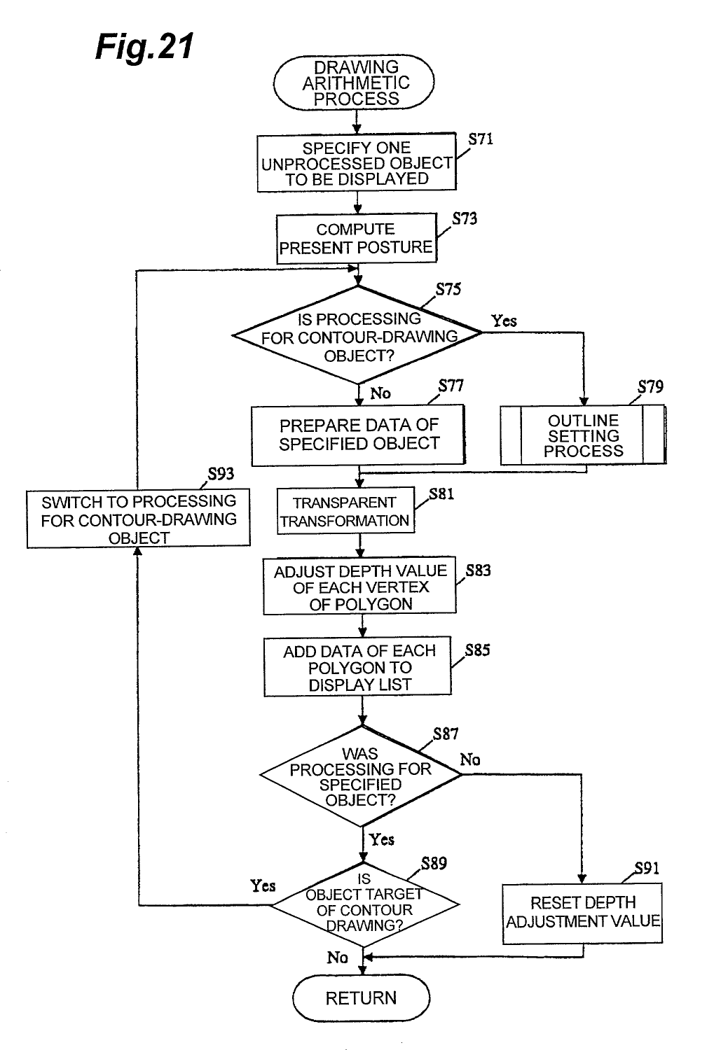

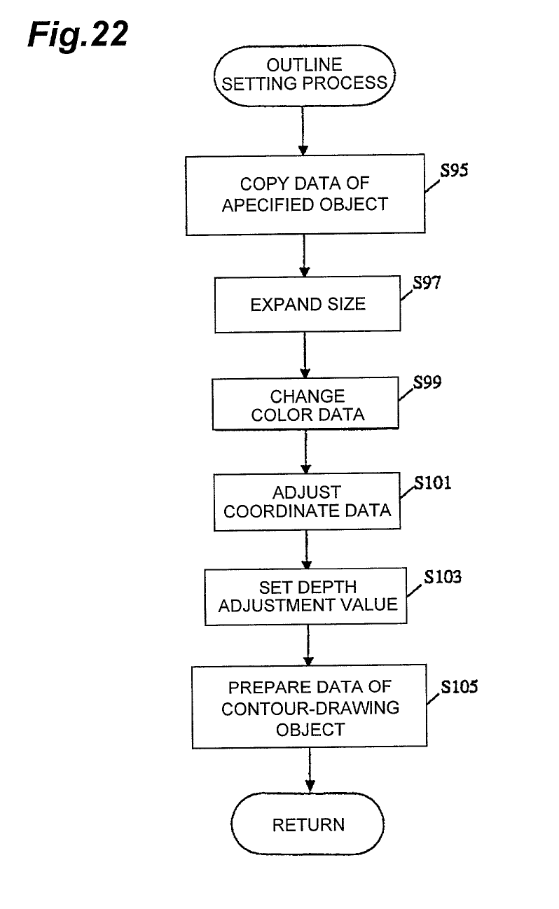

The algorithm of the program in the embodiment 2 will be described below referring to FIG. 8, FIG. 21, and FIG. 22.

Upon starting, based on the operating system stored in the ROM or the like, the arithmetic processor 103 makes the CD-ROM drive 113 read the program and data necessary for execution of the image processing and the game out of the CD-ROM 131 and transfer them to the RAM 105. Then the arithmetic processor 103 executes the program transferred to the RAM 105, thereby implementing the processing described below.

It is noted here that among the control and processing carried out in the home-use game device 101 there are also some cases wherein the practical control and processing is carried out by circuitry outside the arithmetic processor 103 but in cooperation therewith. For convenience' sake of description, the control and processing associated with the arithmetic processor 103 will be described below as being assumed to be carried out directly by the arithmetic processor 103.

In practice the program and data necessary for execution of the image processing and the game are successively read out of the CD-ROM 131 according to proceeding circumstances of processing in response to a command from the arithmetic control unit 103 to be transferred to the RAM 105. In the description hereinafter, however, explanation will be omitted about the reading of data from the CD-ROM 131 and the transfer thereof to the RAM 105 for easier understanding of the invention.

The main flow associated with the display is the same as in Embodiment 1 as far as it is illustrated in FIG. 8. First, objects to be displayed are specified (step S1). Next, the drawing arithmetic process is carried out for one object out of the objects to be displayed (step S2). The drawing arithmetic process will be detailed hereinafter. It is then determined whether the drawing arithmetic process has been completed for all the objects to be displayed (step S3). If there exists an unprocessed object among the objects to be displayed, the flow will return to step S2. When the process has been completed for all the objects to be displayed, the drawing process is carried out in the frame buffer 112 (step S4). Then an image based on the image data stored in the frame buffer 112 is displayed on the display screen 120 of the TV set 121 (step S5).

In the present embodiment the drawing process is carried out by the Z buffer method. In the Z buffer method the drawing process for loading the frame buffer 112 is executed using a display list containing data of the polygons to be drawn. The data of polygons included in the display list includes the coordinates (including the depth value) in the screen coordinate system, texture coordinates, and color data at each vertex of the polygons.

In step S4, the data of polygons is read one by one out of the display list, and the interpolation treatment is carried out based on the coordinates, texture coordinates, and color data at the respective vertexes of the polygon. In the interpolation, coordinates, texture coordinates, and color data of points inside the polygon are computed. On this occasion, the depth value included in the coordinates of the points (including the vertexes of the polygon) inside the polygon is compared with the Z values in the Z buffer 1066 of the pixel ID numbers corresponding to coordinates of the points inside the polygon. Then the subsequent processing is performed only where the depth value is smaller.

Namely, the depth value is stored in the Z-value column 663 of the Z buffer 1066 in correspondence to the pixel ID number corresponding to the coordinates of a point inside the polygon. Then the texel value is read using the texture coordinates and a color of the pixel to be drawn is computed using the texel value and the color data obtained by the interpolation (or the color data of the vertexes of the polygon). The color of the pixel is stored in the color data column 643 of the pixel table 1064 in correspondence to the pixel ID number corresponding to the coordinates of the point inside the polygon. When the texture is not used, the color data obtained by the interpolation (or the color data of the vertexes of the polygon) is stored in the color data column 643 of the pixel table 1064 in correspondence to the pixel ID number corresponding to the coordinates of the point inside the polygon.

Therefore, if there exist a plurality of points inside the polygon to be projected to a single pixel, the color data of the closest point inside the polygon to the view point out of them will be stored in the pixel table 1064. When the closest point inside the polygon to the view point is a point inside the polygon constituting the original object, the color data at the point inside the polygon forming the original object is stored in the pixel table 1064 in correspondence to the pixel ID number corresponding to the pixel.

On the other hand, when the closest point inside the polygon to the view point is a point inside the polygon forming the contour-drawing object, the contour color of the contour-drawing object is stored in the pixel table 1064 in correspondence to the pixel ID number corresponding to the pixel. The contour color of the contour-drawing object is the color data of the polygons of the contour-drawing object.

Next, the drawing arithmetic process of step S2 will be described referring to FIG. 21. First, one unprocessed object to be displayed is specified (step S71). The present posture of the specified object is computed (step S73). Positions of the polygons constituting the object are modified so as to match with the present posture. It is then determined whether the present processing is for a contour-drawing object (step S75). Since in the initial stage one unprocessed object was specified in step S71, the processing is not for a contour-drawing object. Thus the flow transfers to step S77.

In step S77, data of the unprocessed object specified is prepared. Then the data of the unprocessed object thus prepared is subjected to the transparent transformation (step S81). The transparent transformation yields distances from the view point at the respective vertexes of each polygon, i.e., the depth values, for each of the polygons constituting the unprocessed object specified.

Next, for each of the polygons forming the unprocessed object specified (the object as a target of contour drawing), the depth values at the respective vertexes of each polygon are adjusted by the depth adjustment value (step S83). The depth adjustment value is 0 during the processing of the unprocessed object specified. Therefore, this step is skipped virtually. Then the data of each polygon forming the unprocessed object specified is added to the display list (step S85).

Next, it is determined whether the above processing has been done for one unprocessed object specified (step S87). Since the processing has been made for the unprocessed object specified in the first execution, the processor transfers to step S89. In step S89, it is determined whether the unprocessed object specified is a target of contour drawing. In this step it can be determined by determining whether the unprocessed object is an object stored in the outline control table 1058, with reference to the outline control table 1058 of FIG. 6.

If the unprocessed object is an object not stored in the outline control table 1058, the processor will transfer to step S3 of FIG. 8, because the process of drawing the contours is not necessary. If the unprocessed object is an object stored in the outline control table 1058 on the other hand, the processor will move to step S93. In step S93 the object to be processed is switched from one unprocessed object specified, to a corresponding contour-drawing object.

Going back to step S75, the processor again determines whether the present process is for a contour-drawing object. Since the object to be processed was switched to the contour-processing object in step S93, the processor transfers to step S79 this time. The outline setting process is carried out in step S79. The outline setting process will be described in detail referring to FIG. 22.

In FIG. 22 the data of the unprocessed object specified (the original object as a target of contour drawing) is first copied to be prepared as data for the contour-drawing object (step S95). Then the size of the contour-drawing object is expanded from the size of the original object (step S97). The value in the expansion rate column 583 of the outline control table 1058 is used for the expansion of the size. Then the color data of the contour-drawing object is changed (step S99). The data in the color data column 585 of the outline control table 1058 is used as the color data of the contour-drawing object. The color in the color data column 585 is set as a contour color.

Next, adjustment is made for the coordinate data of the contour-drawing object (step S101). The coordinate values in the coordinate adjustment value column 587 of the outline control table 1058 are used for the adjustment of the coordinate data. Namely, the reference position of the contour-drawing object is shifted by the coordinate adjustment values. Then setting of the depth adjustment value used in the step S83 of FIG. 21 is carried out (step S103). The value in the depth adjustment value column 589 of the outline control table 1058 is used as the depth adjustment value. The data of the contour-drawing object generated as described above is prepared for the transparent transformation (step S105). After this stage, the flow returns to step S81 of FIG. 21.

In FIG. 21 the data of the contour-drawing object prepared is subjected to the transparent transformation (step S81). The transparent transformation yields the distances from the view point at the respective vertexes of each polygon, i.e., the depth values thereof, for each of the polygons constituting the contour-drawing object. Then the depth value of each vertex of the polygon is adjusted by the depth adjustment value set in step S103 of FIG. 22, for each of the polygons constituting the contour-drawing object. Namely, each polygon forming the contour-drawing object is positioned behind the original object being a target of contour drawing. Then the data of each polygon of the contour-drawing object resulting from the adjustment of the depth value by the depth adjustment value is added to the display list (step S85).

It is then determined whether the object now under processing is the unprocessed object specified in step S71 (step S87). Since the object now under processing is the contour-drawing object, the flow transfers to step S91. In step S91 the depth adjustment value is reset to 0 in accordance with completion of the processing of the contour-drawing object (step S91). Then the flow transfers to step S3 of FIG. 8.

The above processing results in adding the polygons forming the object to the display list as usual. On the other hand, the polygons constituting the contour-drawing object corresponding to the object are added to the display list after the depth value of each vertex is set greater than that of the object. Then the hidden surface removal process by the Z buffer method is carried out according to the display list and the image is drawn in the frame buffer 112 and displayed on the display screen 120. The contour-drawing object is thus drawn in the contour color except for the part overlapping with the object when observed from the view point.

In the embodiment 2, another important feature is that the contour-drawing object is located relatively behind the original object which is a target of contour drawing. It can also be contemplated that, in step S83 of FIG. 21 in the processing of the original object as a target of contour drawing, the depth value of each vertex of the polygon forming the original object as a target of contour drawing is adjusted so that the original object as a target of contour drawing is positioned ahead of the contour-drawing object, i.e., located closer to the view point.

In Embodiment 2, the contour-drawing object is generated in the size greater than the original object (step S97). Then the position of the contour-drawing object is finely adjusted, for example, so as to provide the whole edge of the object with contours of even thickness (step S101). After that, the object and the contour-drawing object are drawn by the Z buffer method (step S4). Here each polygon forming the object is stored in the display list as usual. On the other hand, each polygon forming the contour-drawing object is added to the display list after the depth value of each vertex of the polygon is shifted backward when viewed from the view point (step S85).

Therefore, when there exist a plurality of polygons to be projected to a single pixel and when the polygon closest to the view point is a polygon forming the object as a target of contour drawing, the pixel is drawn according to the color data of the point inside the polygon forming the object as a target of contour drawing. On the other hand, when there exist a plurality of polygons to be projected to a single pixel and when the closest polygon to the view point is a polygon forming the contour-drawing object, the pixel is drawn according to the color data of the point inside the polygon forming the contour-drawing object, i.e., in the contour color thereof. Finally, there remains only the part of the contour-drawing object surrounding the entire edge of the object and this part is drawn in the contour color.

As a result, the contours can be drawn for the object, without carrying out the process of detecting the contours for the object being a target of contour drawing.

For example, with the disclosure of the Japanese Patent Application Laid-open publication No. Hei-7-85310 which is referred to in the related background art section, it was necessary to decompose a polyhedron or a three-dimensional object being a display object into units of sides of surfaces or polygons and determine whether each side is a side to be displayed as a contour, based on the predetermined algorithm, in order to draw the contours. For this reason, the processing for drawing the contours was extremely complicated.

In contrast with the referenced Publication, the method of the embodiment 2, permits the contours to be drawn simply by generating the contour-drawing object by expanding the object as a target of contour drawing and setting an optional contour color, and by positioning the contour-drawing object behind the object. Therefore, the processing of drawing the contours is much simpler than before, so that the processing speed associated with the contour drawing can be increased.

The increase of processing speed associated with the contour drawing is preferable particularly for the video games. In the video games, the position and shape of the object to be displayed, camera works, etc. vary sequentially according to operation input and the like. Then the projection images according to the sequentially varying contents have to be displayed instantly on the screen. If the processing associated with the contour drawing is complex, the image display speed will be slow even if the contours can be drawn. It is thus important that the procedures associated with the contour drawing be simple, in order to perform the contour drawing without decrease in the display speed.

As described in the embodiment 1, the texture mapping can also be effected on the contour-drawing object in the embodiment 2. In addition, it is also possible to change the texture used in the texture mapping with time in order to implement the dynamic change of the drawing mode of the contour part of the object. It is also possible to change the lightness of the color data set at each vertex of the polygons constituting the contour-drawing object with time, without changing the texture.

The following modifications are applicable to the embodiments 1 and 2.

Modification 1

In the above description, each object was described as a whole model of a character in the video game. However, an object is allowed to be handled as part of a model. For example, it is also possible to set objects in partial units of the head, chest, right arm, left arm, etc. in a human game character and execute the processing of drawing the contours in the object units. When the objects are set in the partial units, contour colors and contour thicknesses can be set finely by setting the depth adjustment value for each part.

Modification 2

In the above description each contour-drawing object was generated by copying the corresponding object, but the contour-drawing object can be generated by another method, for example the contour-drawing object can also be formed more easily by setting the number of polygons forming the contour-drawing object to a value smaller than the number of polygons forming the object. It is also possible to preliminarily prepare the data of the contour-drawing object separately, without generating the contour-drawing object from the object.

Modification 3

In the above description the processing was described on the basis of polygons, particularly, triangular polygons. It is, however, also possible to employ such a configuration that each of the objects and contour-drawing objects is composed of a plurality of polygons including polygonal polygons having four or more vertexes. Further, the processing may also be carried out under the condition that each of the objects and contour-drawing objects is composed of a plurality of surfaces including curved surfaces and each surface is approximated to a polygon or polygons.

Modification 4

In the above description each contour-drawing object was generated by expanding the corresponding object according to the value of expansion rate stored in the expansion rate column 583 of the outline control table 1058. However, another potential modification is such that the contour-drawing object is kept in the size equal to the original object and the size of the original object is reduced.

Modification 5

In the above description the process of rewriting the texture with time was described, but it can also be contemplated that a plurality of textures are prepared and the texture to be mapped is switched one from another with time.

Modification 6

Modifications of hardware used:

FIG. 1 is just an example and there are a variety of potential modifications. It is optional whether the system is provided with the communication interface 115. Since the present invention involves no direct relation with the sound processing, the system does not always have to be provided with the sound processor 109.

The CD-ROM is just an example of the storage medium and the storage medium can also be selected from other storage media including the internal memory such as the ROM, the CD-ROM, DVD-ROM, memory cartridge, floppy disc, magnetic disc, DVD-RAM, and so on. In such cases, the CD-ROM drive 113 needs to be modified so as to be able to read the information from the corresponding medium.

Further, the above embodiments were the examples in which the present invention was substantiated by the computer program, but it can also be substantiated by a combination of the computer program with a dedicated device such as an electronic circuit or the like, or by only the dedicated device such as the electronic circuit.

The present invention was described above in detail based on the embodiments thereof, but it is noted that the present invention is by no means intended to be limited to the above embodiments. The present invention also embraces all modifications falling within the scope not departing from the essence thereof. For example, the above embodiments were the examples in which the present invention was realized on the platform of the home-use game machine, but the present invention may also be realized on the platform of the ordinary computers, arcade game machines, and so on. It can also be contemplated that the present invention is realized using either of personal digital assistants, car navigation systems, etc. as the platform.

It is also noted that the program and data for realizing the present invention are not limited to the form in which they are provided by the recording medium such as the CD-ROM or the like detachably mounted on the computer or the game machine. Namely, the program and data for realizing the present invention may also be provided in the form in which they are recorded in a memory on another device on the network 151 connected via the communication interface 115 and communication line 141 illustrated in FIG. 1 and in which the program and data are successively sent through the communication line 141 into the RAM 105 as occasion may demand.

As detailed above, the present invention permits the drawing of the contours around the object without carrying out the processing of detecting the contours of the object as a target of contour drawing.

What is claimed is:

1. A computer-readable storage medium storing a program for a video game, which draws an object in a virtual space,
wherein said program is structured so as to make a computer perform:
generating a contour-drawing object having a size greater than that of said object;
determining positions of said contour-drawing object and said object so that said contour-drawing object thus generated is positioned behind said object when observed from a view point; and
drawing said object at said position thus determined and drawing said contour-drawing object in an optional contour color and at said determined position except for an overlapping portion between said object and said contour-drawing object when observed from the view point.

2. The computer-readable storage medium according to claim 1, wherein in said drawing, said contour-drawing object and said object are drawn at said respective determined positions in the order named.

3. The computer-readable storage medium according to claim 1, wherein in said drawing, a hidden surface removal treatment using a Z buffer is carried out to draw said object at said determined position and draw said contour-drawing object at said determined position and in the optional contour color.

4. The computer-readable storage medium according to claim 1, wherein in said generation of the contour-drawing object, the contour-drawing object is generated by expanding the size of said object.

5. The computer-readable storage medium according to claim 1, wherein in said determining, the positions of said contour-drawing object and said object are determined so that said contour-drawing object generated appears outside the edge of said object when observed from the view point.

6. The computer-readable storage medium according to claim 1, wherein in said drawing, said object is drawn at said determined position and said contour-drawing object is drawn at said determined position except for the overlapping portion between said object and said contour-drawing object when observed from the view point, by use of texture mapping.

7. The computer-readable storage medium according to claim 1, wherein in said drawing, said object is drawn at said determined position and said contour-drawing object is drawn at said determined position except for the overlapping portion between said object and said contour-drawing object when observed from the view point, by use of texture mapping with texture varying with a lapse of time.

8. A computer-readable storage medium storing a program for a video game, which draws an object comprised of a plurality of polygons,
wherein said program is structured so as to make a computer perform:
generating a contour-drawing object having a size greater than that of said object;
setting a distance from a view point of each polygon forming said contour-drawing object and said object so that said contour-drawing object thus generated is positioned behind said object when observed from the view point; and
drawing each polygon forming said object and drawing each polygon forming said contour-drawing object in an optional contour color in accordance with a drawing order of said polygons resulting from sequencing of said polygons from the greatest distance from the view point, set in said setting.

9. A computer-readable storage medium storing a program for a video game, which draws an object comprised of a plurality of polygons,
wherein said program is structured so as to make a computer perform:
generating a contour-drawing object having a size greater than that of said object;
setting a distance from a view point of each polygon forming said contour-drawing object and said object so that said contour-drawing object thus generated is positioned behind said object when observed from the view point; and
drawing a pixel according to a polygon having a distance closest to the view point, set in said setting, out of polygons projectable into said pixel, wherein when the polygon projected into the pixel is a polygon forming said object, said pixel is drawn according to said polygon and wherein when the polygon projected into the pixel is a polygon forming said contour-drawing object, said pixel is drawn in an optional contour color.

10. An object drawing method in a video game, which draws an object in a virtual space, said object drawing method comprising:
generating a contour-drawing object having a size greater than that of said object;
determining positions of said contour-drawing object and said object so that said contour-drawing object thus generated is positioned behind said object when observed from a view point; and
drawing said object at said position thus determined and drawing said contour-drawing object in an optional contour color and at said determined position except for an overlapping portion between said object and said contour-drawing object when observed from the view point.

11. The object drawing method in the video game according to claim 10, wherein in said drawing, said contour-drawing object and said object are drawn at said respective determined positions in the order named.

12. An object drawing method in a video game, which draws an object comprised of a plurality of polygons, said object drawing method comprising:
generating a contour-drawing object having a size greater than that of said object;
setting a distance from a view point of each polygon forming said contour-drawing object and said object so that said contour-drawing object thus generated is positioned behind said object when observed from the view point; and
drawing each polygon forming said object and drawing each polygon forming said contour-drawing object in an optional contour color in accordance with a drawing order of said polygons resulting from sequencing of said polygons from the greatest distance from the view point, set in said setting.

13. An object drawing method in a video game, which draws an object comprised of a plurality of polygons, said object drawing method comprising:
generating a contour-drawing object having a size greater than that of said object;
setting a distance from a view point of each polygon forming said contour-drawing object and said object so that said contour-drawing object thus generated is positioned behind said object when observed from the view point; and
drawing a pixel according to a polygon having a distance closest to the view point, set in said setting, out of polygons projectable into said pixel, wherein when the polygon projected into the pixel is a polygon forming said object, said pixel is drawn according to said polygon and wherein when the polygon projected into the pixel is a polygon forming said contour-drawing object, said pixel is drawn in an optional contour color.

14. A video game apparatus, which comprises
a computer-readable storage medium storing a program for a video game which draws an object in a virtual space; and
a computer which reads out at least one part of said program from said recording medium to perform, by reading out at least one part of said program from said storage medium, generating a contour-drawing object having a size greater than that of said object;
determining positions of said contour-drawing object and said object so that said contour-drawing object thus generated in said generation is positioned behind said object when observed from a view point; and
drawing said object at said position thus determined by said position determination and drawing said contour-drawing object in an optional contour color and at said position determined by said position determination except for an overlapping portion between said object and said contour-drawing object when observed from the view point.

15. The video game apparatus according to claim 14, wherein said drawing means draws said contour-drawing object and said object at said respective positions determined by said position determining means in the order named.

16. A video game apparatus, which comprises
a computer-readable storage medium storing a program for a video game which draws an object comprised of a plurality of polygons in a virtual space; and
a computer which reads out at least one part of said program from said recording medium to perform, by reading out at least one part of said program from said storage medium, generating a contour-drawing object having a size greater than that of said object; setting a distance from a view point of each polygon forming said contour-drawing object and said object so that said contour-drawing object thus generated by said generation is positioned behind said object when observed from the view point; and drawing each polygon forming said object and drawing each polygon forming said contour-drawing object in an optional contour color in accordance with a drawing order of said polygons resulting from sequencing of said polygons from the greatest distance from the view point, set in said setting.

16. A video game apparatus, which comprises:
a computer-readable storage medium storing a program for a video game which draws an object comprised of a plurality of polygons in a virtual space; and
a computer which reads out at least one part of said program from said recording medium to perform, by reading out at least one part of said program from said storage medium,
generating a contour-drawing object having a size greater than that of said object;
setting a distance from a view point of each polygon forming said contour-drawing object and said object so that said contour-drawing object thus generated in said generation is positioned behind said object when observed from the view point; and
drawing a pixel according to a polygon having a distance closest to the view point, set in said setting out of polygons projectable into said pixel, wherein when the polygon projected into the pixel is a polygon forming said object, said pixel according to said polygon is drawn and wherein when the polygon projected into the pixel is a polygon forming said contour-drawing object, said pixel in an optional contour color is drawn.

18. A video game apparatus which draws an object in a virtual space, comprising:
a computer; and
a computer-readable storage medium storing a program to be executed by said computer,
wherein said program is structured so as to make said computer perform:
generating a contour-drawing object having a size greater than that of said object;
determining positions of said contour-drawing object and said object so that said contour-drawing object thus generated in said generation is positioned behind said object when observed from a view point; and
drawing said object at said position thus determined in said position determination and drawing said contour-drawing object in an optional contour color and at said position determined in said position determination except for an overlapping portion between said object and said contour-drawing object when observed from the view point.

19. A computer program for a video game, which draws an object in a virtual space,
wherein said computer program is structured so as to make a computer perform:
generating a contour-drawing object having a size greater than that of said object;
determining positions of said contour-drawing object and said object so that said contour-drawing object thus generated is positioned behind said object when observed from a view point; and
drawing said object at said position thus determined and drawing said contour-drawing object in an optional contour color and at said determined position except for an overlapping portion between said object and said contour-drawing object when observed from the view point.

20. A computer program for a video game, which draws an object comprised of a plurality of polygons,
wherein said computer program is structured so as to make a computer perform:
generating a contour-drawing object having a size greater than that of said object;
setting a distance from a view point of each polygon forming said contour-drawing object and said object so that said contour-drawing object thus generated is positioned behind said object when observed from the view point; and
drawing each polygon forming said object and drawing each polygon forming said contour-drawing object in an optional contour color in accordance with a drawing order of said polygons resulting from sequencing of said polygons from the greatest distance from the view point, set in said setting.

21. A computer program for a video game, which draws an object comprised of a plurality of polygons,
wherein said computer program is structured so as to make a computer perform:
generating a contour-drawing object having a size greater than that of said object;
setting a distance from a view point of each polygon forming said contour-drawing object and said object so that said contour-drawing object thus generated is positioned behind said object when observed from the view point; and
drawing a pixel according to a polygon having a distance closest to the view point, set in said setting, out of polygons projectable into said pixel, wherein when the polygon projected into the pixel is a polygon forming said object, said pixel is drawn according to said polygon and wherein when the polygon projected into the pixel is a polygon forming said contour-drawing object, said pixel is drawn in an optional contour color.
